(19) United States
(12) Patent Application Publication
(10) Pub. No.: US 2011/0033796 A1
(43) Pub. Date: Feb. 10, 2011

(54) METHOD OF PREPARING TONER AND TONER PREPARED THEREBY

(76) Inventors: Hiroshi YAMADA, Numazu-shi (JP); Akinori Saitoh, Numazu-shi (JP); Masahide Yamada, Numazu-shi (JP)

Correspondence Address: OBLON, SPIVAK, MCCLELLAND MAIER & NEUSTADT, L.L.P., 1940 DUKE STREET, ALEXANDRIA, VA, 22314, US

(21) Appl. No.: 12/830,634

(22) Filed: Jul. 6, 2010

(30) Foreign Application Priority Data
Aug. 4, 2009 (JP) 2009-181236

(51) Int. Cl. G03G 9/12; G03G 9/08

(52) U.S. Cl. 430/113; 430/137.22

(57) ABSTRACT

A method of preparing a toner, including dissolving toner constituents including a binder resin or a binder resin precursor, a colorant and a release agent in an organic solvent to prepare a first liquid; emulsifying the first liquid in an aqueous medium to prepare a second liquid having a viscosity of from 50 to 800 mPa·sec; and at least flowing the second liquid almost vertically down along the wall surface of a pipe in which the air pressure is depressurized to 70 kPa or less twice while keeping a temperature of the second liquid not higher than a Tg of the parent particle through the wall surface thereof to volatilize the organic solvent, wherein a solid content of a slurry after volatilized is from 15 to 50%, and a ratio of the solid content to a solid content of a slurry before volatilized is from 1.05 to 2.00.

### BACKGROUND OF THE INVENTION

1. Field of the Invention

The present invention relates to a method of preparing a toner producing high-quality images in image forming technologies using electrophotography, such as copiers, laser printers and facsimile machines.

2. Discussion of the Background

Recent strong demand for higher quality images from the market has spurred development of electrophotographic image forming apparatuses and toners. So-called spherical toners having narrow toner particle diameter distributions are known to be suitable for producing such higher quality images. Such toners behave predictably when developed and improve reproducibility of microscopic dots. However, spherical toners, with their small particle diameters and narrow particle diameter distributions are difficult to remove properly. In particular, it is difficult for blade cleaners to reliably remove such toners.

Therefore, methods of deforming toner particles are known. This lowers fluidity of toners to make the toner particles easier to remove with blade cleaners. However, when the toner particles are too deformed, they behave unpredictably and exhibit deterioration in reproducibility of microscopic dots. Further, a toner layer on unfixed transfer material has a low toner fill rate and low heat conductivity when fixed, resulting in deterioration of much sought-after low-temperature fixability. Such a tendency becomes pronounced particularly when pressure on the toner is small when fixed.

Japanese Patent No. 3473194 (Japanese published unexamined application No. 9-15903, or JP-H09-15903-A) discloses a method of preparing a toner for developing an electrostatic latent image, including mixing a binder resin and a colorant in a solvent which is not mixed with water to prepare a composition, dispersing the composition in an aqueous medium under the presence of dispersion stabilizer to prepare a suspension liquid, removing the solvent from the suspension liquid with heat and/or depressurization to form particles having concavities and convexities on their surfaces, and spheronizing or deforming the particles with heat. However, the resultant nonuniform amorphous toner has unstable chargeability.

JP-2005-49858-A discloses a method of preparing toner particles including dispersing a filler-contained dispersion in which a resin and/or its precursor in a solvent and a filler are dispersed in an aqueous medium to form an oil-in-water dispersion, forming an accumulation layer formed of at least apart of the filler in an oil droplet, and removing the solvent from the oil-in-water dispersion to prepare resin particles. However, the resin particles do not sufficiently have both cleanability and low-temperature fixability.

Japanese Patent No. 4030937 (-2005-10723-A) discloses a method of preparing a toner, including dispersing a solution or a dispersion in which a toner composition is dissolved or dispersed in an organic solvent in an aqueous medium including a particle dispersant to prepare an emulsified dispersion, and removing the organic solvent from the emulsified dispersion while applying a shear force thereto with a continuous vacuum defoamer. The toner has cleanability and thin line reproducibility without scattering. However, the efficiency of the process of removing the organic solvent needs further improving to prepare a spherical toner having the requisite small particle diameter and narrow particle diameter distribution.

Japanese Patent No. 3762075 (JP-H11-133665-A) discloses another method of preparing a toner, including dissolving a binder including a urethane-modified polyester resin (i) and an unmodified polyester resin (ii) in a solvent to prepare a solution, and dispersing the solution in an aqueous medium. Alternatively, Japanese Patent No. 376207 (JP-H11-149180-A) discloses yet another method of preparing a toner including a toner binder including a resin (i) formed by elongating and/or cross-linking a polyester prepolymer including an isocyanate group (A1) with amines (B) in an aqueous medium and a polymer (ii) unreactable with (A1) and (B), and a colorant.

Alternatively, JP-2000-292981-A discloses a method of preparing a toner including a binder formed of a polymeric resin (A) and a low-molecular-weight resin (B), and a colorant in an aqueous medium.

Japanese Patent No. 3762075 (JP-H11-133665-A), Japanese Patent No. 376207 (JP-H11-149180-A) and JP-2000-292981-A can all prepare a toner having good heat-resistant storage stability, low-temperature fixability, and hot offset resistance, and producing images having good glossiness. However, the efficiency of the processes involved, particularly when removing the organic solvent, cannot be said to be sufficient to prepare a spherical toner having a small particle diameter and a narrow particle diameter distribution.

For these reasons, a need exists for a method of efficiently preparing a toner having both good reproducibility of microscopic dots and good cleanability.

### SUMMARY OF THE INVENTION

Accordingly, an object of the present invention is to provide a method of preparing toner, capable of efficiently preparing a toner having good reproducibility of microscopic dots and cleanability.

Another of the present invention is to provide a toner prepared by the method.

These objects and other objects of the present invention, either individually or collectively, have been satisfied by the discovery of a method of preparing a toner having a parent particle, comprising:

dissolving or dispersing toner constituents comprising at least one of a binder resin and a binder resin precursor, a colorant and a release agent in an organic solvent to prepare a first liquid;

emulsifying or dispersing the first liquid in an aqueous medium to prepare a second liquid having a viscosity of from 50 to 800 mPa·sec when measured by Brookfield viscometer at 60 rpm and a temperature of 25° C.; and

at least flowing the second liquid almost vertically down along the wall surface of a pipe in which the air pressure is depressurized to have a pressure not greater than 70 kPa as a liquid film twice while keeping a temperature of the second liquid not higher than a glass transition temperature of the parent particle through the wall surface of the pipe to volatilize the organic solvent,

wherein a solid content (b) of a slurry after the organic solvent is volatilized is from 15 to 50%, and a ratio [(b)/(a)] of the solid content (b) to a solid content (a) of a slurry before the organic solvent is volatilized is from 1.05 to 2.00.

These and other objects, features and advantages of the present invention will become apparent upon consideration of the following description of the preferred embodiments of the present invention taken in conjunction with the accompanying drawings.

### BRIEF DESCRIPTION OF THE DRAWINGS

Various other objects, features and attendant advantages of the present invention will be more fully appreciated as the same becomes better understood from the detailed description when considered in connection with the accompanying drawings in which like reference characters designate like corresponding parts throughout and wherein:

FIG. 1 is a schematic view illustrating an embodiment of the pipe for use in the process of volatilizing an organic solvent in the method of preparing a toner having a parent particle of the present invention;

FIGS. 2A and 2B are schematic views for explaining the shape factors SF-1 and SF-2 of the toner having a parent particle of the present invention;

FIG. 3 is a schematic view illustrating an embodiment of conventional image forming apparatuses in which the toner having a parent particle of the present invention can be used.

### DETAILED DESCRIPTION OF THE INVENTION

The present invention provides a method of preparing toner, capable of efficiently preparing a toner having good reproducibility of microscopic dots and cleanability. More particularly, the present invention relates to a method of preparing a toner having a parent particle, comprising: dissolving or dispersing toner constituents comprising at least one of a binder resin and a binder resin precursor, a colorant and a release agent in an organic solvent to prepare a first liquid;

emulsifying or dispersing the first liquid in an aqueous medium to prepare a second liquid having a viscosity of from 50 to 800 mPa·sec when measured by Brookfield viscometer at 60 rpm and a temperature of 25° C.; and

at least flowing the second liquid almost vertically down along the wall surface of a pipe in which the air pressure is depressurized to have a pressure not greater than 70 kPa as a liquid film twice while keeping a temperature of the second liquid not higher than a glass transition temperature of the parent particle through the wall surface of the pipe to volatilize the organic solvent,

wherein a solid content (b) of a slurry after the organic solvent is volatilized is from 15 to 50%, and a ratio [(b)/(a)] of the solid content (b) to a solid content (a) of a slurry before the organic solvent is volatilized is from 1.05 to 2.00.

Hereinafter, the toner having a parent particle is referred to as “a toner”.

When the second liquid has a viscosity less than 50 mPa·sec, a liquid film becomes difficult to uniformly form on the wall surface when almost vertically flowed down along the wall surface of a pipe. When greater than 800 mPa·sec, the liquid film becomes too thick to efficiently volatilize an organic solvent.

When the pipe has an inner pressure greater than 70 kPa, an organic solvent is difficult to efficiently volatilize. When the second liquid flowing down along the wall surface of the pipe has a temperature (in the pipe) greater than a glass transition temperature of the parent particle, particles produced by volatilization of the organic solvent tend to agglutinate.

Further, when the process of volatilizing the organic solvent is single, the organic solvent is difficult to efficiently volatilize. Namely, so as to completely volatilize the organic solvent at a time, much water volatilizes together and a solid content of a slurry after the organic solvent is volatilized is concentrated. Therefore, a liquid film is difficult to uniformly form on the wall surface and the organic solvent is difficult to efficiently volatilize. When the number of the process of volatilizing an organic solvent is not less than two, water volatilizing together is decreased to efficiently remove the organic solvent. Multiple number of the process of volatilizing an organic solvent can efficiently remove the organic solvent. However, apparatus cost increases according to the number of process, and the number of process is preferably determined from income and outgo between heat energy cost and apparatus cost. Two to five times of the process are preferably performed in terms of efficiency.

When a solid content of a slurry after the organic is volatilized is greater than 50%, the liquid film becomes too thick to efficiently volatilize the organic solvent. When the solid content is less than 15%, a moisture and the organic solvent are so much that heat energy increases, resulting in deterioration of toner productivity per unit.

When the ratio [(b)/(a)] of the solid content (b) to the solid content (a) of a slurry before the organic solvent is volatilized is greater than 2.00, the liquid film becomes too thick to efficiently volatilize the organic solvent. When less than 1.05, the efficiency of removing the organic solvent deteriorates.

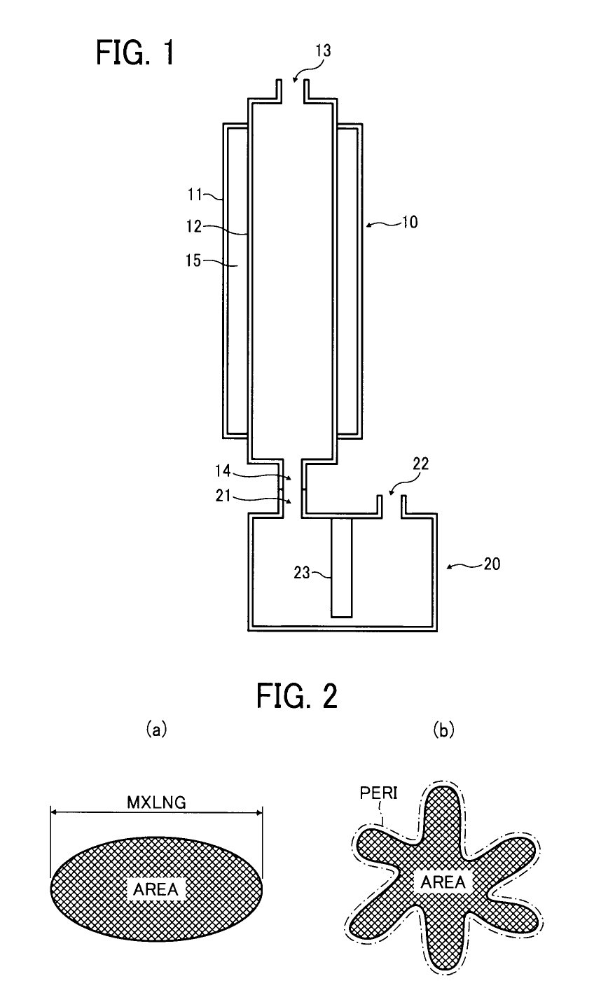

FIG. 1 is a schematic view illustrating an embodiment of the pipe for use in the process of volatilizing an organic solvent in the method of preparing toner of the present invention.

In FIG. 1, a double pipe 10 includes an outer pipe 11, an inner pipe 12, a feed opening 13 and a discharge opening 14. A heat medium 15 is located between the outer pipe 11 and the inner pipe 12, and the outer wall surface of the inner pipe 12 is heated. Further, the inner pipe 12 is depressurized by a vacuum pump (not shown) to have an inner pressure not greater than 70 kPa. The second liquid is fed from the feed opening 13 located on the top of the inner pipe 12 to form a liquid film (flow) flowing almost vertically down along the inner wall surface of the inner pipe 12. Then, since the second liquid has a temperature not greater than a glass transition temperature of the parent particle through the inner wall surface of the inner pipe 12, the parent particles do not soften to agglutinate and the organic solvent can efficiently be volatilized from the second liquid. The inner pipe 12 may be oscillated so as to prevent the liquid film on the inner wall surface thereof from being nonuniformly formed.

A container 20 includes a feed opening 21, a discharge opening 22 and a partition plate 23, and the discharge opening 14 of the double pipe 10 is connected with the feed opening 21 of the container 20. Therefore, the organic solvent volatilized from the second liquid is discharged from the discharge opening 22 through the discharge opening 14 and the feed opening 21. The second liquid from which the organic solvent is volatilized is fed into the container 20 through the discharge opening 14 and the feed opening 21. Then, the partition plate 23 prevents the liquid from flowing out from the discharge opening 22.

As mentioned above, the toner constituents includes a binder resin and/or a binder resin precursor. The binder resin precursor may be a compound having an active hydrogen group and a polymer having a functional group reactable with the active hydrogen group.

When the compound having an active hydrogen group and the polymer having a functional group reactable with the active hydrogen group are used to prepare the first liquid, the polymer having a functional group reactable with the active hydrogen group is reacted with the compound having an active hydrogen group. Such a reaction is preferably performed in the process of preparing the second liquid.

The polymer having a functional group reactable with the active hydrogen group is preferably a polyester having an isocyanate group (hereinafter referred to as a “prepolymer (A)”).

Specific examples of the active hydrogen group include a hydroxyl group (such as an alcoholic hydroxyl group and a phenolic hydroxyl group), an amino group, a carboxyl group, a mercapto group, etc. In particular, the alcoholic hydroxyl group and the amino group are preferably used.

Hereinafter, cases where the prepolymer (A) is used as the polymer having a functional group reactable with the active hydrogen group and amines (B) is used as the compound having an active hydrogen group will be explained.

A urea-modified polyester prepared by reacting the prepolymer (A) and the amines (B) as a cross-linker and/or an elongator is easy to control its polymeric component, and is preferably used for a dry toner, particularly, a toner having oilless low-temperature fixability (wide releasability and fixability without application of oil to a heating medium for fixing the toner). Particularly, a terminally-modified urea-modified polyester is more preferably used because the resultant toner has oilless low-temperature fixability while maintaining high fluidity and transparency of the polyester in a fixable temperature.

The prepolymer (A) is prepared by reacting the polyester having an active hydrogen group with polyisocyanate having an active hydrogen group (PIC). The active hydrogen group includes a hydroxyl group (such as an alcoholic hydroxyl group and a phenolic hydroxyl group), an amino group, a carboxyl group, a mercapto group, etc. In particular, the alcoholic hydroxyl group is preferably used.

The polyester having an alcoholic hydroxyl group as an active hydrogen group is prepared by polycondensating a polyol (PO) and a polycarboxylic acid (PC).

Specific examples of the polyols (PO) include diols (DIO), polyols (TO) having three or more hydroxyl groups, and mixtures of DIO and TO.

Specific examples of the diol (DIO) include alkylene glycols, alkylene ether glycols, alicyclic diols, bisphenols, alkylene oxide adducts of alicyclic dials, alkylene oxide adducts of bisphenols, etc. Specific examples of the alkylene glycols include ethylene glycol, 1,2-propylene glycol, 1,3-propylene glycol, 1,4-butanediol and 1,6-hexanediol. Specific examples of the alkylene ether glycols include diethylene glycol, triethylene glycol, dipropylene glycol, polyethylene glycol, polypropylene glycol and polytetramethylene ether glycol. Specific examples of the alicyclic diols include 1,4-cyclohexanedimethanol and hydrogenated bisphenol A. Specific examples of the bisphenols include bisphenol A, bisphenol F and bisphenol S. Specific examples of the alkylene oxide adducts of alicyclic diols include adducts of the alicyclic diols mentioned above with an alkylene oxide (e.g., ethylene oxide, propylene oxide and butylene oxide). Specific examples of the alkylene oxide adducts of bisphenols include adducts of the bisphenols mentioned above with an alkylene oxide (e.g., ethylene oxide, propylene oxide and butylene oxide). These can be used alone or in combination.

Among these compounds, alkylene glycols having from 2 to 12 carbon atoms and adducts of bisphenols with an alkylene oxide are preferable. More preferably, adducts of bisphenols with an alkylene oxide, and mixtures of an adduct of bisphenols with an alkylene oxide and an alkylene glycol having from 2 to 12 carbon atoms are used.

Specific examples of the TO include multivalent aliphatic alcohol having 3 to 8 or more valences such as glycerin, trimethylolethane, trimethylolpropane, pentaerythritol and sorbitol; phenol having 3 or more valences such as trisphenol PA, phenolnovolak, cresolnovolak; and adducts of the above-mentioned polyphenol having 3 or more valences with an alkylene oxide. These can be used alone or in combination.

Specific examples of the polycarboxylic acids (PC) include dicarboxylic acids (DIC) and polycarboxylic acids having three or more carboxyl groups (TC). A mixture of the dicarboxylic acids (DIC) and the polycarboxylic acid having three or more carboxyl groups (TC) is preferably used.

Specific examples of the dicarboxylic acids (DIC) include alkylene dicarboxylic acids (e.g., succinic acid, adipic acid and sebacic acid); alkenylene dicarboxylic acids (e.g., maleic acid and fumaric acid); aromatic dicarboxylic acids (e.g., phthalic acid, isophthalic acid, terephthalic acid and naphthalene dicarboxylic acids; etc. Among these compounds, alkenylene dicarboxylic acids having from 4 to 20 carbon atoms and aromatic dicarboxylic acids having from 8 to 20 carbon atoms are preferably used.

Specific examples of the polycarboxylic acid having three or more (preferably from 3 to 8) hydroxyl groups (TO) include aromatic polycarboxylic acids having from 9 to 20 carbon atoms (e.g., trimellitic acid and pyromellitic acid).

Anhydrides or lower alkyl esters (e.g., methyl esters, ethyl esters or isopropyl esters) of the dicarboxylic acids (DIC), the polycarboxylic acids having three or more hydroxyl groups (TC) or their mixture can also be used as the polycarboxylic acid (PC). Specific examples of the lower alkyl esters include a methyl ester, an ethyl ester, an isopropyl ester, etc.

The polyol (PO) and the polycarboxylic acid (PC) are heated at a temperature of from 150 to 280° C. under the presence of a known catalyst such as tetrabutoxy titanate and dibutyltinoxide. Then, water generated is removed, under a reduced pressure if desired, to prepare a polyester having an alcoholic hydroxyl group. PO and PC are mixed such that an equivalent ratio of the hydroxyl group to the carboxylic group is typically from 1 to 2, preferably from 1 to 1.5, and more preferably from 1.02 to 1.3.

Specific examples of the PIC include aliphatic polyisocyanate such as tetramethylenediisocyanate, hexamethylenediisocyanate and 2,6-diisocyanatemethylcaproate; alicyclic polyisocyanate such as isophoronediisocyanate and cyclohexylmethanediisocyanate; aromatic diisocyanate such as tolylenedisocyanate and diphenylmethanediisocyanate; aroma aliphatic diisocyanate such as α,α,α′,α′-tetramethylxylylenediisocyanate; isocyanurate; the above-mentioned polyisocyanate blocked with phenol derivatives, oxime and caprolactam; and their combinations.

The PIC is preferably mixed with the polyester having an alcoholic hydroxyl group at from 40 to 140° C. such that an equivalent ratio of the isocyanate group to the alcoholic hydroxyl group is typically from to 1 o 5, preferably from 1.2 to 4, and more preferably from 1.5 to 2.5. When greater than 5, low temperature fixability of the resultant toner deteriorates. When less than 1, a urea content in ester of the modified polyester decreases and hot offset resistance of the resultant toner deteriorates.

When the PIC is mixed with the polyester having an alcoholic hydroxyl group, a solvent may be included. Specific examples of the solvent include solvents inactive with isocyanate, e.g., aromatic solvents such as toluene and xylene; ketones such as acetone, methyl ethyl ketone and methyl isobutyl ketone; esters such as ethylacetate; amides such as dimethylformamide and dimethylacetoamide; and ethers such as tetrahydrofuran.

The prepolymer (A) preferably has a weight-average molecular weight of from 3,000 to 20,000. When less than 3,000, the reaction speed between the prepolymer (A) and the amines (B) is difficult to control to stably produce a urea-modified polyester. When greater than 20,000, the reaction between the prepolymer (A) and the amines (B) sufficiently performed and offset resistance of the resultant toner deteriorates.

The prepolymer (A) preferably includes a constitutional component coming from polyisocyanate (PIC) of from 0.5 to 40% by weight, preferably from 1 to 30% by weight and more preferably from 2 to 20% by weight. When less than 0.5% by weight, hot offset resistance of the resultant toner deteriorates, and in addition, the toner does not have both of heat resistant storage stability and low-temperature fixability. When greater than 40% by weight, low-temperature fixability of the resultant toner deteriorates.

Specific examples of the amines (B) include diamines (B1), polyamines (B2) having three or more amino groups, amino alcohols (B3), amino mercaptans (B4), amino acids (B5) and blocked amines (B6) in which the amines (B1-B5) mentioned above are blocked. Particularly, diamines (B1) alone or a mixture of the diamine (B1) and the polyamine (B2) having three or more amino groups are preferably used.

Specific examples of the diamines (B1) include aromatic diamines such as phenylene diamine, diethyltoluene diamine and 4,4′-diaminodiphenyl methane; alicyclic diamines such as 4,4′-diamino-3,3′-dimethyldicyclohexyl methane, diaminocyclohexane and isophoronediamine; aliphatic diamines such as ethylene diamine, tetramethylene diamine and hexamethylene diamine; etc., and their mixtures.

Specific examples of the polyamines (B2) having three or more amino groups include diethylene triamine, triethylene tetramine, etc., and their mixtures.

Specific examples of the amino alcohols (B3) include ethanol amine and hydroxyethyl aniline, etc., and their mixtures.

Specific examples of the amino mercaptan (B4) include aminoethyl mercaptan and aminopropyl mercaptan, etc., and their mixtures.

Specific examples of the amino acids (B5) include amino propionic acid and amino caproic acid, etc., and their mixtures.

Specific examples of the blocked amines (B6) include ketimine compounds which are prepared by reacting amines with ketones such as acetone, methyl ethyl ketone and methyl isobutyl ketone; oxazoline compounds, etc., and their mixtures.

Known catalysts such as dibutyltinlaurate and dioctyltinlaurate may be used when the prepolymer (A) is reacted with the amine (B). The reaction time is typically from 10 min to 40 hrs, and preferably from 2 to 24 hrs. The reaction temperature is typically from 0 to 150° C., and preferably from 40 to 98° C.

The equivalent ratio of the content of the prepolymer (A) to the amines (B) is from 0.5 to 2, preferably from ⅔ to 1.5 and more preferably from ⅚ to 1.2. When greater than 2 or less than 0.5, the urea-modified polyester decreases in molecular weight, resulting in deterioration of hot offset resistance of the resultant toner.

The molecular weight of the urea-modified polyesters can optionally be controlled using an elongation anticatalyst, if desired.

Specific examples of the elongation anticatalyst include monoamines such as diethyle amine, dibutyl amine, butyl amine and lauryl amine, and blocked amines, i.e., ketimine compounds prepared by blocking the monoamines mentioned above.

In the present invention, when preparing the first liquid, a modified polyester such as a urea-modified polyester and a urethane-modified polyester may be used instead of or together with the prepolymer (A).

The urea-modified polyester may have a urethane bond together with a urea bond. A molar ratio of the urethane bond to the urea bond is typically from 0 to 9, preferably from 0.25 to 4, and more preferably from ⅔ to 3/7. When greater than 9, hot offset resistance of the resultant toner deteriorates.

The modified polyester can be prepared by one-shot methods, etc.

When the prepolymer (A) is reacted with the amine (B), a solvent may be included. Specific examples of the solvent include solvents inactive with isocyanate, e.g., aromatic solvents such as toluene and xylene; ketones such as acetone, methyl ethyl ketone and methyl isobutyl ketone; esters such as ethylacetate; amides such as dimethylformamide and dimethylacetoamide; and ethers such as tetrahydrofuran.

The solvent is typically used in an amount of from 0 to 300 parts by weight, preferably from 0 to 100, and more preferably from 25 to 70 parts by weight, per 100 parts by weight of the prepolymer (A).

The modified polyester typically has a weight-average molecular weight not less than 10,000, preferably from 20,000 to 10,000,000 and more preferably from 30,000 to 1,000,000. When less than 10,000, hot offset resistance of the resultant toner deteriorates.

The modified polyester typically has a number-average molecular weight of from 2,000 to 15,000, preferably from 2,000 to 10,000, and more preferably from 2,000 to 8,000 when a polyester is not included in preparation of the first liquid. When less than 2,000, papers toner images are developed on are wounded around a fixing roller. When greater than 15,000, the low-temperature fixability of the resultant toner and the glossiness of full-color images produced thereby deteriorate.

In the present invention, when preparing the first liquid, a polyester is preferably used instead of or together with the prepolymer (A) because the resultant toner both has heat resistant storage stability and low-temperature fixability.

The polyester is prepared by polycondensating the polyol (PO) and the polycarboxylic acid (PC).

The polyester preferably includes tetrahydrofuran (THF)-soluble components in a weight-average molecular weight of from 1,000 to 30,000. When less than 1,000, the heat-resistant preservability deteriorates because an oligomer components increase. When greater than 30,000, the offset resistance deteriorates because the polyester resin is not sufficiently modified due to a steric hindrance.

In the present invention, the number-average molecular weight and the weight-average molecular weight are polystyrene-converted molecular weights measured by GPC (gel permeation chromatography).

The polyester preferably has an acid value of from 1 to 50 KOH mg/g. When less than 1.0 KOH mg/g, a basic compound does not stabilize the dispersion in preparing a toner. In addition, when the prepolymer (A), the amines (B) and the polyester are used together in preparing the first liquid, the prepolymer (A) and the amines (B) easily react with each other, a toner is not stably prepared. When greater than 50.0 KOH mg/g, when the prepolymer (A), the amines (B) and the polyester are used together in preparing the first liquid, the prepolymer (A) and the amines (B) do not fully react with each other, resulting in poor hot offset resistance.

The acid value in the present invention is measured by a method disclosed in JIS K0070-1992.

The polyester preferably has a glass transition temperature of from 35 to 65° C. When less than 35° C., the heat-resistant preservability is insufficient. When greater than 65° C., the low-temperature fixability deteriorates.

A combination of the urea-modified polyester and the polyester improves low-temperature fixability of the resultant toner, and glossiness of images produced thereby. The polyester can be dissolved in a solution in which the prepolymer (A) and the amines (B) are reacted with each other. Further, the urea-modified polyester and the urethane-modified polyester can be used together.

When the urea-modified polyester and the polyester are used together, the urea-modified polyester is preferably compatible with at least a part of the polyester. Therefore, the urea-modified polyester preferably has a polyester component similar to the composition of the polyester.

A weight ratio of the urea-modified polyester to the polyester is from 5/95 to 80/20, preferably from 5/95 to 30/70, more preferably from 5/95 to 25/75, and even more preferably from 7/93 to 20/80. When less than 5/95, the hot offset resistance deteriorates, and in addition, it is disadvantageous for the resultant toner to have both heat resistant storage stability and low-temperature fixability.

The binder resin preferably includes the polyester in an amount of from 50 to 100% by weight. When less than 50% by weight, it is disadvantageous for the resultant toner to have both heat resistant storage stability and low-temperature fixability.

In the present invention, it is preferable that the toner constituents further includes a modified layered inorganic mineral in which metallic cations are at least partially modified with organic cations.

The modified layered inorganic mineral is preferably a mineral having a basic smectite crystal structure, which is modified with an organic cation. This controls the shape of the parent particle and improves chargeability of the resultant toner.

Specific examples of the layered inorganic mineral include, but are not limited to, montmorillonite, bentonite, beidelite, nontronite, saponite, hectolite, etc., and their mixtures.

Specific examples of the organic cations include, but are not limited to, quarternary ammonium ion, phosphonium ion, imidazolium ion, etc., and the quarternary ammonium ion is preferably used.

Specific examples of the quarternary ammonium ion include, but are not limited to, trimethyl stearyl ammonium ion, dimethyl stearyl benzyl ammonium ion, dimethyl octadecyl ammonium ion, oleylbis(2-hydroxyethyl)methyl ammonium ion, etc.

Specific examples of marketed products of the modified layered inorganic mineral include BENETONE 34, BENTONE 52, BENTONE 38, BENTONE 27, BENTONE 57, BENTONE SD1, BENTONE SD2 and BENTONE SD3 from Elementis Plc.; CRAYTONE 34, CRAYTONE 40, CRAYTONE HT, CRAYTONE 2000, CRAYTONE AF, CRAYTONE APA and CARYTONE HY from SCP, Inc.; ESBEN, ESBEN E, ESBEN C, ESBEN NZ, ESBEN NZ70, ESBEN W, ESBEN N400, ESBEN NX, ESBEN NX80, ESBEN NO12S, ESBEN NEZ, ESBEN N012, ESBENE WX and ESBEN NE from HOJUN Co., Ltd.; and KUNIBIS 110, KUNIBIS 120 and KUNIBIS 127 from Kunimine Industries Co., Ltd.

The modified layered inorganic mineral is preferably used as a complex mixed with the binder resin in preparing the first liquid. The complex of the modified layered inorganic mineral and the binder resin, i.e., a masterbatch is prepared by applying a high shear force to a mixture of the modified layered inorganic mineral and the binder resin. An organic solvent may be used to increase an interaction between the modified layered inorganic mineral and the binder resin. A three-roll mill, etc, is used to apply the high shear force to the mixture as a disperser.

The masterbatch may be prepared by flushing methods. Specifically, an aqueous paste including a modified layered inorganic mineral is mixed and kneaded with a binder resin and an organic solvent to transfer the modified layered inorganic mineral to the binder resin, and a moisture and the organic solvent are removed from the mixture. The flushing methods do not need drying because a wet cake of the modified layered inorganic mineral can be used as it is.

The complex of the modified layered inorganic mineral and the binder resin preferably includes the modified layered inorganic mineral having a particle diameter not less than 1 μm in an amount of from 0 to 15% by volume. When greater than 15% by volume, effects for the shape and chargeability of the resultant toner deteriorate.

The parent particle preferably includes the modified layered inorganic mineral in an amount of from 0.1 to 5% by weight. When less than 0.1% by weight, effects for the shape and chargeability of the resultant toner deteriorate. When greater than 5% by weight, fixability thereof deteriorates.

Specific examples of the colorant for use in the present invention include any known dyes and pigments such as carbon black, Nigrosine dyes, black iron oxide, NAPHTHOL YELLOW S, HANSA YELLOW (10G, 5G and G), Cadmium Yellow, yellow iron oxide, loess, chrome yellow, Titan Yellow, polyazo yellow, Oil Yellow, HANSA YELLOW (GR, A, RN and R), Pigment Yellow L, BENZIDINE YELLOW (G and GR), PERMANENT YELLOW (NCG), VULCAN FAST YELLOW (5G and R), Tartrazine Lake, Quinoline Yellow Lake, ANTHRAZANE YELLOW BGL, isoindolinone yellow, red iron oxide, red lead, orange lead, cadmium red, cadmium mercury red, antimony orange, Permanent Red 4R, Para Red, Fire Red, p-chloro-o-nitroaniline red, Lithol Fast Scarlet G, Brilliant Fast Scarlet, Brilliant Carmine BS, PERMANENT RED (F2R, F4R, FRL, FRLL and F4RH), Fast Scarlet VD, VULCAN FAST RUBINE B, Brilliant Scarlet G, LITHOL RUBINE GX, Permanent Red F5R, Brilliant Carmine 6B, Pigment Scarlet 3B, Bordeaux 5B, Toluidine Maroon, PERMANENT BORDEAUX F2K, HELIO BORDEAUX BL, Bordeaux 10B, BON MAROON LIGHT, BON MAROON MEDIUM, Eosin Lake, Rhodamine Lake B, Rhodamine Lake Y, Alizarine Lake, Thioindigo Red B, Thioindigo Maroon, Oil Red, Quinacridone Red, Pyrazolone Red, polyazo red, Chrome Vermilion, Benzidine Orange, perynone orange, Oil Orange, cobalt blue, cerulean blue, Alkali Blue Lake, Peacock Blue Lake, Victoria Blue Lake, metal-free Phthalocyanine Blue, Phthalocyanine Blue, Fast Sky Blue, INDANTHRENE BLUE (RS and BC), Indigo, ultramarine, Prussian blue, Anthraquinone Blue, Fast Violet B, Methyl Violet Lake, cobalt violet, manganese violet, dioxane violet, Anthraquinone Violet, Chrome Green, zinc green, chromium oxide, viridian, emerald green, Pigment Green B, Naphthol Green B, Green Gold, Acid Green Lake, Malachite Green Lake, Phthalocyanine Green, Anthraquinone Green, titanium oxide, zinc oxide, lithopone and their mixtures. The toner preferably include the colorant in an amount of from 1 to 15% by weight, and more preferably from 3 to 10% by weight.

The colorant for use in the present invention can be used as a masterbatch combined with a resin.

The masterbatch for use in the toner of the present invention is typically prepared by mixing and kneading a resin and a colorant upon application of high shear stress thereto. In this case, an organic solvent can be used to heighten an interaction of the colorant with the resin. In addition, flushing methods in which an aqueous paste including a colorant is mixed with a resin solution of an organic solvent to transfer the colorant to the resin solution and then the aqueous liquid and organic solvent are separated and removed can be preferably used because the resultant wet cake of the colorant can be used as it is.

Specific examples of the resin for use in the masterbatch or for use in combination with masterbatch pigment include the modified and unmodified polyester resins mentioned above; styrene polymers and substituted styrene polymers such as polystyrene, poly-p-chlorostyrene and polyvinyltoluene; styrene copolymers such as styrene-p-chlorostyrene copolymers, styrene-propylene copolymers, styrene-vinyltoluene copolymers, styrene-vinylnaphthalene copolymers, styrene-methyl acrylate copolymers, styrene-ethyl acrylate copolymers, styrene-butyl acrylate copolymers, styrene-octyl acrylate copolymers, styrene-methyl methacrylate copolymers, styrene-ethyl methacrylate copolymers, styrene-butyl methacrylate copolymers, styrene-methyl α-chloromethacrylate copolymers, styrene-acrylonitrile copolymers, styrene-vinyl methyl ketone copolymers, styrene-butadiene copolymers, styrene-isoprene copolymers, styrene-acrylonitrile-indene copolymers, styrene-maleic acid copolymers and styrene-maleic acid ester copolymers; and other resins such as polymethyl methacrylate, polybutylmethacrylate, polyvinyl chloride, polyvinyl acetate, polyethylene, polypropylene, polyesters, epoxy resins, epoxy polyol resins, polyurethane resins, polyamide resins, polyvinyl butyral resins, acrylic resins, rosin, modified rosins, terpene resins, aliphatic or alicyclic hydrocarbon resins, aromatic petroleum resins, chlorinated paraffin, paraffin waxes, etc. These resins are used alone or in combination.

Specific examples of the release agent include natural waxes such as vegetable waxes, e.g., carnauba wax, cotton wax, Japan wax and rice wax; animal waxes, e.g., bees wax and lanolin; mineral waxes, e.g., ozokelite and ceresine; and petroleum waxes, e.g., paraffin waxes, microcrystalline waxes and petrolatum. In addition, synthesized waxes can also be used. Specific examples of the synthesized waxes include synthesized hydrocarbon waxes such as Fischer-Tropsch waxes and polyethylene waxes; and synthesized waxes such as ester waxes, ketone waxes and ether waxes. In addition, fatty acid amides such as 1,2-hydroxylstearic acid amide, stearic acid amide and phthalic anhydride imide; and low molecular weight crystalline polymers such as acrylic homopolymer and copolymers having a long alkyl group in their side chain, e.g., poly-n-stearyl methacrylate, poly-n-laurylmethacrylate and n-stearyl acrylate-ethyl methacrylate copolymers, can also be used.

The wax for use in the toner of the present invention has a low melting point of from 50 to 120° C. Thereby, hot offset resistance can be improved without applying an oil to the fixing roller used. In the present invention, the melting point of the wax is a maximum heat absorption peak measured by a differential scanning calorimeter (DSC).

The parent particle preferably includes a release agent in an amount of from 1 to 20% by weight.

The organic solvent used for the first liquid preferably has a boiling point less than 100° C. to be removed by volatilization. Specific examples of such a solvent include toluene, xylene, benzene, carbon tetrachloride, methylene chloride, 1,2-dichloroethane, 1,1,2-trichloroethane, trichloroethylene, chloroform, monochlorobenzene, dichloroethylidene, methyl acetate, ethyl acetate, methyl ethyl ketone, methyl isobutyl ketone, etc. These solvents can be used alone or in combination. Among these solvents, aromatic solvents such as toluene and xylene; and halogenated hydrocarbons such as methylene chloride, 1,2-dichloroethane, chloroform, and carbon tetrachloride are preferably used.

Then, an organic solvent capable of dissolving a binder resin and/or a compound having an active hydrogen group, and a polymer having a functional group reactable with the active hydrogen group lowers viscosity of the first liquid and narrows a particle diameter distribution of the resultant toner.

The aqueous medium used for preparing the second liquid includes, but is not limited to, water alone and mixtures of water with a solvent which can be mixed with water. Specific examples of the solvent include alcohols such as methanol, isopropanol and ethylene glycol; dimethylformamide; tetrahydrofuran; cellosolves such as methyl cellosolve; and lower ketones such as acetone and methyl ethyl ketone.

Known dispersers such as low-speed shearing dispersers, high-speed shearing dispersers, friction dispersers, high-pressure jet dispersers, ultrasonic dispersers can be used for emulsifying or dispersing the first liquid in an aqueous medium to prepare the second liquid. Among these, high-speed shearing dispersers are preferably used. When the high-speed shearing disperser is used, the rotation speed is not particularly limited, but the rotation speed is typically from 1,000 to 30,000 rpm, and preferably from 5,000 to 20,000 rpm. The dispersion time is not also particularly limited, but is typically from 0.1 to 5 minutes. The temperature in the dispersion process is typically from 0 to 150° C. (under pressure), and preferably from 40 to 98° C. The higher the temperature, the easier the dispersion because viscosity of the second liquid lowers.

The content of the aqueous medium to 100 parts by weight of solid contents of the first liquid is typically from 50 to 2,000 parts by weight, and preferably from 100 to 1,000 parts by weight. When the content is less than 50 parts by weight, the dispersion in the aqueous medium is not satisfactory, the resultant parent particle does not have a desired particle diameter. In contrast, when the content is greater than 2,000, the production cost increases.

The aqueous medium may include a dispersant when necessary. The dispersant improves dispersibility of the second liquid and narrows a particle diameter distribution of the resultant toner. The dispersant includes surfactants, inorganic particulate dispersants, particulate resin dispersants, etc.

Specific examples of the surfactants include, but are not limited to, anionic surfactants such as alkylbenzene sulfonic acid salts, α-olefin sulfonic acid salts, and phosphoric acid salts; cationic surfactants such as amine salts (e.g., alkyl amine salts, aminoalcohol fatty acid derivatives, polyamine fatty acid derivatives and imidazoline), and quaternary ammonium salts (e.g., alkyltrimethyl ammonium salts, dialkyldimethyl ammonium salts, alkyldimethyl benzyl ammonium salts, pyridinium salts, alkyl isoquinolinium salts and benzethonium chloride); nonionic surfactants such as fatty acid amide derivatives, polyhydric alcohol derivatives; and ampholytic surfactants such as alanine, dodecyldi(aminoethyl)glycin, di(octylaminoethyle)glycin, and N-alkyl-N,N-dimethylammonium betaine. A surfactant having a fluoroalkyl group is preferably used because a dispersion having good dispersibility even with a small amount thereof.

Specific examples of anionic surfactants having a fluoroalkyl group include fluoroalkyl carboxylic acids having from 2 to 10 carbon atoms and their metal salts, disodium perfluorooctanesulfonylglutamate, sodium 3-{omega-fluoroalkyl(C6-C11)oxy}-1-alkyl(C3-C4) sulfonate, sodium-{omega-fluoroalkanoyl(C6-C8)-N-ethylamino}-1-propane sulfonate, fluoroalkyl(C11-C20) carboxylic acids and their metal salts, perfluoroalkylcarboxylic acids and their metal salts, perfluoroalkyl(C4-C12) sulfonate and their metal salts, perfluorooctanesulfonic acid diethanol amides, N-propyl-N-(2-hydroxyethyl)perfluorooctanesulfone amide, perfluoroalkyl(C6-C10)sulfoneamidepropyltrimethylammonium salts, salts of perfluoroalkyl(C6-C10)-N-ethylsulfonyl glycin, monoperfluoroalkyl(C6-C16)ethylphosphates, etc.

Specific examples of marketed products of such surfactants having a fluoroalkyl group include SURFLON S-111, S-112 and S-113, which are manufactured by Asahi Glass Co., Ltd.; FRORARD FC-93, FC-95, FC-98 and FC-129, which are manufactured by Sumitomo 3M Ltd.; UNIDYNE DS-101 and DS-102, which are manufactured by Daikin Industries, Ltd.; MEGAFACE F-110, F-120, F-113, F-191, F-812 and F-833 which are manufactured by Dainippon Ink and Chemicals, Inc.; ECTOP EF-102, 103, 104, 105, 112, 123A, 306A, 501, 201 and 204, which are manufactured by Tohchem Products Co., Ltd.; FUTARGENT F-100 and F150 manufactured by Neos; etc.

Specific examples of the cationic surfactants include, but are no limited to, primary aliphatic, secondary and tertiary amines having a fluoroalkyl group, aliphatic quaternary ammonium salts such as perfluoroalkyl(C6-C10)sulfoneamidepropyltrimethylammonium salts, benzalkonium salts, benzetonium chloride, pyridinium salts, imidazolinium salts, etc.

Specific examples of marketed products thereof include SURFLON S-121 (from Asahi Glass Co., Ltd.); FRORARD FC-135 (from Sumitomo 3M Ltd.); UNIDYNE DS-202 (from Daikin Industries, Ltd.); MEGAFACE F-150 and F-824 (from Dainippon Ink and Chemicals, Inc.); ECTOP EF-132 (from Tohchem Products Co., Ltd.); FUTARGENT F-300 (from Neos); etc.

Specific examples of the inorganic particulate dispersants include, but are not limited to, tricalcium phosphate, calcium carbonate, titanium oxide, colloidal silica and hydroxyapatite, etc.

Specific examples of the particulate resin dispersants include, but are not limited to, particulate PMMA, particulate polystyrene, particulate styrene-acrylonitrile copolymers, etc.

Specific examples of the marketed products of the particulate resin dispersants include PB-200H (from Kao Corp.), SGP (Soken Chemical & Engineering Co., Ltd.), TECHNOPOLYMER SB (Sekisui Plastics Co., Ltd.), SPG-3G (Soken Chemical & Engineering Co., Ltd.), and MICROPEARL (Sekisui Fine Chemical Co., Ltd.).

Further, the inorganic particulate dispersants, the particulate resin dispersants and a polymeric protection colloid may be used together. Specific examples of the polymeric protection colloids include, but are not limited to, polymers and copolymers prepared using monomers such as acids (e.g., acrylic acid, methacrylic acid, α-cyanoacrylic acid, α-cyanomethacrylic acid, itaconic acid, crotonic acid, fumaric acid, maleic acid and maleic anhydride), acrylic monomers having a hydroxyl group (e.g., β-hydroxyethylacrylate, β-hydroxyethyl methacrylate, β-hydroxypropyl acrylate, β-hydroxypropyl methacrylate, γ-hydroxypropyl acrylate, γ-hydroxypropyl methacrylate, 3-chloro-2-hydroxypropyl acrylate, 3-chloro-2-hydroxypropyl methacrylate, diethyleneglycolmonoacrylic acid esters, diethyleneglycolmonomethacrylic acid esters, glycerinmonoacrylic acid esters, N-methylolacrylamide and N-methylolmethacrylamide), vinyl alcohol and its ethers (e.g., vinyl methyl ether, vinyl ethyl ether and vinyl propyl ether), esters of vinyl alcohol with a compound having a carboxyl group (i.e., vinyl acetate, vinyl propionate and vinyl butyrate); acrylic amides (e.g, acrylamide, methacrylamide and diacetoneacrylamide) and their methylol compounds, acid chlorides (e.g., acrylic acid chloride and methacrylic acid chloride), and monomers having a nitrogen atom or an alicyclic ring having a nitrogen atom (e.g., vinyl pyridine, vinyl pyrrolidone, vinyl imidazole and ethylene imine). In addition, polymers such as polyoxyethylene compounds (e.g., polyoxyethylene, polyoxypropylene, polyoxyethylenealkyl amines, polyoxypropylenealkyl amines, polyoxyethylenealkyl amides, polyoxypropylenealkyl amides, polyoxyethylene nonylphenyl ethers, polyoxyethylene laurylphenyl ethers, polyoxyethylene stearylphenyl esters, and polyoxyethylene nonylphenyl esters); and cellulose compounds such as methyl cellulose, hydroxyethyl cellulose and hydroxypropyl cellulose, can also be used as the polymeric protective colloids.

In the present invention, after an organic solvent is removed by volatilization from the second liquid to form a parent particle, the parent particle is preferably refined by washing and drying.

In the present invention, the parent particles preferably has a volume-average particle diameter of from 3 to 7 μm. When less than 3 μm, a one-component developer has a problem of filming over a developing roller and fusion bond of the toner to a blade forming a thin layer thereof tend to occur. A two-component developer melts and adheres to a surface of a carrier to deteriorate chargeability thereof when stirred for long periods in an image developer. When larger than 7 μm, the resultant toner has a difficulty in producing high resolution and quality images. In addition, a two-component developer has a large variation of the particle diameters of the toner when consumed and fed therein for long periods.

The parent particles preferably has a ratio of a volume-average particle diameter to a number-average particle diameter thereof of from 1.0 to 1.2. When greater than 1.2, the resultant toner does not uniformly behave, resulting in deterioration of reproducibility of microscopic dots.

The volume-average particle diameter and the number-average particle diameter are measured by a Coulter counter.

In the present invention, the parent particles preferably include particles having a diameter not greater than 2 μm in an amount of 10% by number or less. When greater than 10% by number, a two-component developer melts and adheres to a surface of a carrier to deteriorate chargeability thereof when stirred for long periods in an image developer.

The parent particles preferably have an average circularity of from 0.94 to 0.99. When less than 0.94, the shape of the resultant toner is so far from a sphere that the toner deteriorates in transferability and does not produce high-quality images. When greater than 0.99, photoreceptors and cleaning belts in image forming apparatuses using the toner are poorly cleaned, resulting in contaminated images.

The content of the parent particles having a diameter not greater than 2 μm and the circularity are measured by a flow-type particle image analyzer

In the present invention, the parent particles preferably have a shape factor SF-1 of from 110 to 200, and more preferably from 120 to 180. When less than 110, the toner is difficult to clean with a blade. When greater than 200, the toner particles are deformed, do not smoothly transfer and nonuniformly behave, resulting in deterioration of transferability. Further, the toner is not stably charged and becomes fragile. As a result, the toner is further micronized in a developer, resulting in deterioration of durability of the developer.

Further, the parent particles preferably have a shape factor SF-2 of from 110 to 300. When less than 110, the toner deteriorates in cleanability. When greater than 300, the toner deteriorates in transferability.

The shape factors SF-1 and SF-2 are determined by the following formulae (1) and (2).

FIGS. 2A and 2B are schematic views for explaining the shape factors SF-1 and SF-2 of the toner having a parent particle of the present invention.

The shape factor SF-1 represents a degree of roundness of a toner, and is determined in accordance with the following formula (1):

SF-1={(MXLNG)²/AREA}×(100π/4) (1)

wherein MXLNG [FIG. 2A] represents an absolute maximum length of a particle and AREA represents a projected area thereof.

When the SF-1 is 100, the toner has the shape of a complete sphere. As SF-1 becomes greater, the toner becomes more amorphous.

SF-2 represents the concavity and convexity of the shape of the toner, and specifically a square of a peripheral length PERI [FIG. 2B] of an image projected on a two-dimensional flat surface is divided by an area of the image (AREA) and multiplied by 100π/4 to determine SF-2 as the following formula (2) shows.

SF-2={(PERI)²/AREA}×(100π/4) (2)

When SF-2 is 100, the surface of the toner has less concavities and convexities. As SF-2 becomes greater, the concavities and convexities thereon become more noticeable.

Typically, a full-color copier transferring with multicolor development increases in a toner amount on its photoreceptor more than a black-and-white copier transferring with monochromatic development, and therefore only a conventional amorphous toner is difficult to improve transfer efficiency of the full-color copier. In addition, the conventional amorphous toner causes scrape and friction between a photoreceptor and a cleaning member, a transferer and a cleaning member, and a photoreceptor and an intermediate transferer. Therefore, fusion bonding and filming of a toner are made on the surfaces of a photoreceptor and an intermediate transferer, resulting in deterioration of transfer efficiency. Then, toner images having four colors respectively are difficult to uniformly transfer. Further, the intermediate transferer is likely to have problems of uneven color and color balance and is difficult to stably produce high-quality full-color images. The toner prepared by the method of the present invention can solve such problems.

The parent particle of the present invention preferably has a glass transition temperature of from 40 to 70° C. When less than 40° C., toner blocking in an image developer and filming over a photoreceptor tend to occur. When greater than 70° C., the low-temperature fixability of the resultant toner deteriorates.

In the present invention, a charge controlling agent is fixed on the surface of the toner particles, for example, by the following method. Toner particles including at least a resin and a colorant are mixed with particles of a release agent in a container using a rotor. In this case, it is preferable that the container does not have a portion projected from the inside surface of the container, and the peripheral velocity of the rotor is preferably from 40 to 150 m/sec.

Specific examples of the charge controlling agent include, but are not limited to, known charge controlling agents such as Nigrosine dyes, triphenylmethane dyes, metal complex dyes including chromium, chelate compounds of molybdic acid, Rhodamine dyes, alkoxyamines, quaternary ammonium salts (including fluorine-modified quaternary ammonium salts), alkylamides, phosphor and compounds including phosphor, tungsten and compounds including tungsten, fluorine-containing activators, metal salts of salicylic acid, salicylic acid derivatives, copper phthalocyanine, perylene, quinacridone, azo pigments and polymers having a functional group such as a sulfonate group, a carboxyl group, a quaternary ammonium group, etc.

Specific examples of the marketed products of the charge controlling agents include BONTRON 03 (Nigrosine dyes), BONTRON P-51 (quaternary ammonium salt), BONTRON S-34 (metal-containing azo dye), E-82 (metal complex of oxynaphthoic acid), E-84 (metal complex of salicylic acid), and E-89 (phenolic condensation product), which are manufactured by Orient Chemical Industries Co., Ltd.; TP-302 and TP-415 (molybdenum complex of quaternary ammonium salt), which are manufactured by Hodogaya Chemical Co., Ltd.; COPY CHARGE PSY VP2038 (quaternary ammonium salt), COPY BLUE (triphenyl methane derivative), COPY CHARGE NEG VP2036 and NX VP434 (quaternary ammonium salt), which are manufactured by Hoechst AG; LRA-901, and LR-147 (boron complex), which are manufactured by Japan Carlit Co., Ltd.

The content of the charge controlling agent is determined depending on the species of the binder resin used, whether or not an additive is added and toner manufacturing method (such as dispersion method) used, and is not particularly limited. However, the content of the charge controlling agent is typically from 0.1 to 10 parts by weight, and preferably from 0.2 to 5 parts by weight, per 100 parts by weight of the binder resin included in the toner. When greater than 10 parts by weight, the toner has too large charge quantity, and thereby the electrostatic force of a developing roller attracting the toner increases, resulting in deterioration of the fluidity of the toner and decrease of the image density of toner images.

The charge controlling agent may be included in the form of a complex with a resin, i.e., as a masterbatch, and may be included when the first liquid is prepared.

Inorganic particulate material is preferably added to the parent particle to assist fluidity, developability and chargeability of the resultant toner. Specific examples of the inorganic particulate material include, but are not limited to, silica, alumina, titanium oxide, barium titanate, magnesium titanate, calcium titanate, strontium titanate, zinc oxide, tin oxide, quartz sand, clay, mica, sand-lime, diatom earth, chromium oxide, cerium oxide, red iron oxide, antimony trioxide, magnesium oxide, zirconium oxide, barium sulfate, barium carbonate, calcium carbonate, silicon carbide, silicon nitride, their mixtures, etc. Among these inorganic particulate materials, a combination of a hydrophobic silica and a hydrophobic titanium oxide is preferably used as a fluidity improver. In particular, the hydrophobic silica and the hydrophobic titanium oxide each having an average particle diameter not greater than 50 nm are more preferably used. This prevents the inorganic particulate material from releasing from a toner when stirred and mixed in an image developer to be properly charged.

The inorganic particulate material preferably has an average primary particle diameter of from 5 nm to 2 μm, and more preferably from 5 to 500 nm. In addition, the inorganic particulate material preferably has a specific surface area of from 20 to 500 m²/g when measured by a BET method. The toner preferably includes the inorganic particulate material in an amount of from 0.01 to 5% by weight, and more preferably from 0.01 to 2.0% by weight.

The toner prepared by the method of the present invention can be used for a two-component developer in which the toner is mixed with a magnetic carrier. A content of the toner is preferably from 1 to 10 parts by weight per 100 parts by weight of the carrier.

Suitable carriers for use in the two component developer include known carrier materials such as iron powders, ferrite powders, magnetite powders, magnetic resin carriers, which have a particle diameter of from about 20 to 200 μm.

A surface of the carrier may be coated by a resin. Specific examples of such resins to be coated on the carriers include amino resins such as urea-formaldehyde resins, melamine resins, benzoguanamine resins, urea resins, and polyamide resins, and epoxy resins. In addition, vinyl or vinylidene resins such as acrylic resins, polymethylmethacrylate resins, polyacrylonitirile resins, polyvinyl acetate resins, polyvinyl alcohol resins, polyvinyl butyral resins, polystyrene resins, styrene-acrylic copolymers, halogenated olefin resins such as polyvinyl chloride resins, polyester resins such as polyethyleneterephthalate resins and polybutyleneterephthalate resins, polycarbonate resins, polyethylene resins, polyvinyl fluoride resins, polyvinylidene fluoride resins, polytrifluoroethylene resins, polyhexafluoropropylene resins, vinylidenefluoride-acrylate copolymers, vinylidenefluoride-vinylfluoride copolymers, copolymers of tetrafluoroethylene, vinylidenefluoride and other monomers including no fluorine atom, and silicone resins.

An electroconductive powder may optionally be included in the toner. Specific examples of such electroconductive powders include metal powders, carbon blacks, titanium oxide, tin oxide, and zinc oxide.

The average particle diameter of such electroconductive powders is preferably not greater than 1 μm. When the particle diameter is too large, it is hard to control the resistance of the resultant toner.

The toner prepared by the method of the present invention can also be used as a one-component magnetic developer or a one-component non-magnetic developer.

The one-component developer and the two-component developer using the toner prepared by the method of the present invention can be used for conventional image forming apparatuses to produce images.

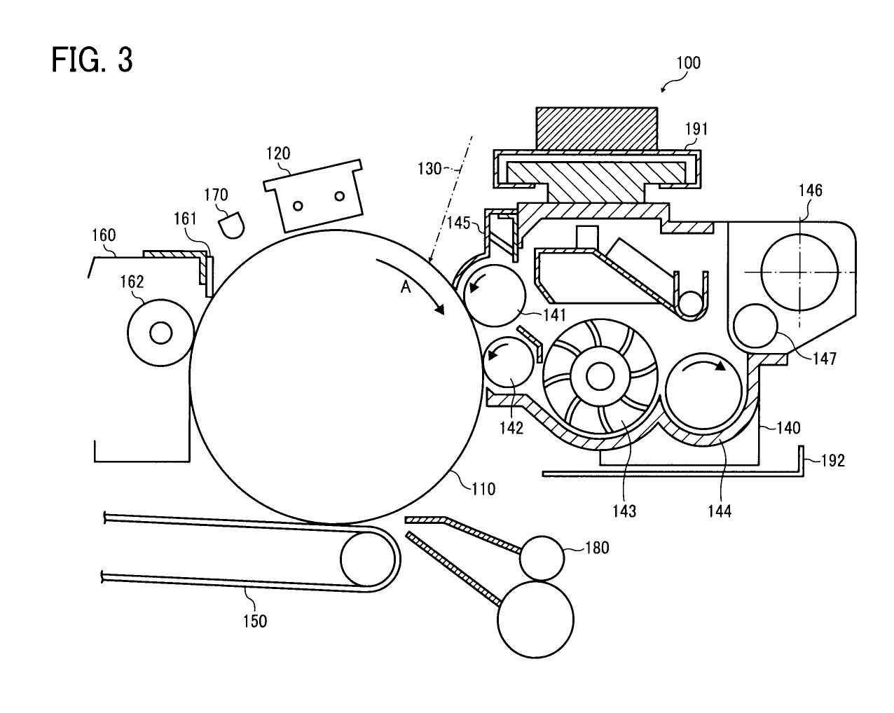

FIG. 3 is a schematic view illustrating an embodiment of conventional image forming apparatuses in which the toner prepared by the method of the present invention can be used.

In FIG. 3, in an electrophotographic image forming apparatus 100, a photoreceptor drum 110 rotates in A direction, a charger 120 is located around the photoreceptor drum 110, and a laser beam 130 corresponding to an image read from an original document is irradiated thereto. Further, an image developer 140, a transferer 150, a cleaner 160, a discharge lamp 170 and a paper feeder 180 are located around the photoreceptor drum 110. The image developer 140 includes a developing rollers 141 and 142, a paddle-shaped stirrer 143, a stirrer 144, a doctor 145, a toner feeder 146 and a feed roller 147. The cleaner 160 includes a cleaning blade 161 and a cleaning brush 162. Guide rails 191 and 192 for detaching or supporting the image developer 140 are located above and below the image developer 140.

Having generally described this invention, further understanding can be obtained by reference to certain specific examples which are provided herein for the purpose of illustration only and are not intended to be limiting. In the descriptions in the following examples, the numbers represent weight ratios in parts, unless otherwise specified.

### EXAMPLES

### Example 1

First, a particulate resin dispersion, a polyester, a prepolymer, a masterbatch (complex formed of a mixture of a modified layered inorganic mineral and a resin), a toner constituents dispersion and an aqueous medium were respectively prepared by the following methods to prepare a toner.

### (Preparation of Particulate Resin Dispersion)

683 parts of water, 11 parts of a sodium salt of an adduct of a sulfuric ester with ethyleneoxide methacrylate (ELEMINOL RS-30 from Sanyo Chemical Industries, Ltd.), 83 parts of styrene, 83 parts of methacrylate, 110 parts of butylacrylate and 1 part of persulfate ammonium were mixed in a reactor vessel including a stirrer and a thermometer, and the mixture was stirred for 15 min at 400 rpm to prepare a white emulsion therein. The white emulsion was heated to have a temperature of 75° C. and reacted for 5 hrs. Further, 30 parts of an aqueous solution of persulfate ammonium having a concentration of 1% were added thereto and the mixture was reacted at 75° C. for 5 hrs to prepare an aqueous dispersion a [particulate dispersion liquid 1] of a vinyl resin (a copolymer of a sodium salt of an adduct of styrene-methacrylate-butylacrylate-sulfuric ester with ethyleneoxide methacrylate). The [particulate dispersion liquid 1] was measured by LA-920 from HORIBA, Ltd. to find a volume-average particle diameter thereof was 105 nm. A part of the [particulate dispersion liquid 1] was dried to isolate a resin component therefrom. The resin component had a glass transition temperature (Tg) of 59° C. and a weight-average molecular weight of 150,000.

### (Preparation of Polyester)

229 parts of an adduct of bisphenol A with 2 moles of ethyleneoxide, 529 parts of an adduct of bisphenol A with 3 moles of propyleneoxide, 208 parts terephthalic acid, 46 parts of adipic acid and 2 parts of dibutyltinoxide were polycondensated in a reactor vessel including a cooling pipe, a stirrer and a nitrogen inlet pipe for 5 hrs at a normal pressure and 230° C. Further, after the mixture was depressurized by 10 to 15 mm Hg and reacted for 5 hrs, 44 parts of trimellitic acid anhydride were added thereto and the mixture was reacted for 2 hrs at a normal pressure and 180° C. to prepare a polyester 1. The polyester 1 included THF-soluble components having a weight-average molecular weight of 2,300, a Tg of 45° C. and an acid value of 20 mg KOH/g.

### (Preparation of Prepolymer)

In a reaction container with a condenser, a stirrer and a nitrogen introducing tube, 795 parts of an adduct of bisphenol A with 2 moles of ethyleneoxide, 200 parts of isophthalic acid, 65 parts of terephthalic acid and 2 parts of dibutyltinoxide were mixed. The mixture was reacted for 8 hrs at 210° C. under a normal pressure. Then, after the reaction was further performed for 5 hrs under a reduced pressure of from 10 to 15 mmHg while dehydrated, the reaction product was cooled to have a temperature of 80° C. Further, 1,300 parts of ethylacetate and 170 parts of isophoronediisocyanate were added thereto and the reaction was performed for 2 hrs to prepare a prepolymer 1. The prepolymer 1 had a weight-average molecular weight of 5,000.

### (Preparation of Masterbatch)

1,200 parts of water, 174 parts of ion-exchanged bentonite with quaternary ammonium ion BENTONE 57 from Elementis Plc., and 1,570 parts of the polyester 1 were mixed in a HENSCHEL MIXER from Mitsui Mining Co., Ltd. to prepare a mixture. The mixture was kneaded at 150° C. for 30 min by a two-roll mill, extended upon application of pressure, and pulverized by PULVERIZER from Hosokawa Micron Corp. to prepare a masterbacth 1. The modified bentonite in the masterbatch had a volume-average particle diameter of 0.4 μm, and included particles having a diameter not less than 1 μm in an amount of 2% by volume.

### (Preparation of Toner Constituents Dispersion [First Liquid])

23.4 parts of the prepolymer 1, 123.6 parts of the polyester 1, 20 parts of the masterbatch 1 and 80 parts of ethylacetate were dispersed in a container to prepare a dispersion. Meanwhile, 15 parts of carnauba wax, 20 parts of carbon black and 120 parts ethylacetate were dispersed by a beads mill for 30 min to prepare another dispersion. The two dispersions were mixed and stirred for 5 min at 12,000 rpm by T.K. Homo Mixer, and further dispersed by a beads mill for 10 min to prepare a third dispersion. 2.9 parts of isophoronediamine were added thereto, and the dispersion was stirred for 5 min at 12,000 rpm by T.K. Homo Mixer to prepare a toner constituents liquid 1.

On the other hand, 23.4 parts of the prepolymer 1, 141.6 parts of the polyester 1, 7 parts organosilica sol MEK-ST from Nissan Chemical Industries, Ltd. having a concentration of solid contents 30% by weight and an average primary particle diameter of 15 nm and 64 parts of ethylacetate were dispersed in a container to prepare a dispersion. Meanwhile, 15 parts of carnauba wax, 20 parts of carbon black and 120 parts ethylacetate were dispersed by a beads mill for 30 min to prepare another dispersion. The two dispersions were mixed and stirred for 5 min at 12,000 rpm by T.K. Homo Mixer, and further dispersed by a beads mill for 10 min to prepare a third dispersion. 2.9 parts of isophoronediamine were added thereto, and the dispersion was stirred for 5 min at 12,000 rpm by T.K. Homo Mixer to prepare a toner constituents liquid 2.

### (Preparation of Aqueous Medium)

529.5 parts of ion-exchanged water, 70 parts of the particulate dispersion liquid 1 and 0.5 parts of sodium dodecylbenzenesulfonate were mixed by T.K. Homo Mixer at 12,000 rpm to prepare an aqueous medium 1.

### (Preparation of Second Liquid)

24 kgs of the toner constituents liquid 1 were mixed with 36 kgs of the aqueous medium 1 to be reacted with each other while stirred for 30 min to prepare 60 kgs of an emulsion 1. The emulsion (second liquid) has a viscosity of 500 mPa·sec when measured by Brookfield viscometer at 60 rpm and a temperature of 25° C. The emulsion included ethylacetate in an amount of 20% by weight and a solid content (a slurry solid content before an organic solvent is volatilized) in an amount of 22% by weight.

### (Volatilization of Organic Solvent)

An organic solvent in the emulsion (second liquid) was volatilized using the double pipe 10 in FIG. 1 in the following five processes under respective conditions.

[First Process]: 60 kgs of the emulsion were fed at a feeding speed (A) of 90 kgs/hr into the double pipe 10 when the inner pipe 12(1) have an inner wall surface temperature of 60° C. and an inner pressure of 75 mmHg (10 kPa). The emulsion was heated while the temperature of a liquid film flow of the emulsion was maintained at a glass transition temperature of the parent particle or less through the wall surface of the pipe to volatilize ethylacetate. The inner pipe 12 (1) has a heat-transfer area (S) of 0.18 m², a length of 2 m, a heat-transfer surface diameter 28.4 mm and a circumferential length (L) of the heat-transfer surface of 89.2 mm. The time for volatilizing ethylacetate, i.e., the time from starting feeding 60 kgs of the emulsion into the double pipe 10 until finishing feeding the slurry into the container 20 was about 40 min. The slurry after the first de-solvent process had a weight about 47 kgs, ethylacetate in a remained amount of 6.3% by weight and a solid content of 28% by weight. The slurry had a temperature not higher than 40° C.

[Second Process]: Next, 47 kgs of the emulsion were fed at a feeding speed (A) of 90 kgs/hr into the double pipe 10 when the inner pipe 12 (2) have an inner wall surface temperature of 60° C. and an inner pressure of 60 mmHg (8 kPa). The emulsion was heated while the temperature of a liquid film flow of the emulsion was maintained at a glass transition temperature of the parent particle or less through the wall surface of the pipe to volatilize ethylacetate. The inner pipe 12 (2) has a heat-transfer area (S) of 0.18 m², a length of 2 m, a heat-transfer surface diameter 28.4 mm and a circumferential length (L) of the heat-transfer surface of 89.2 mm. The time for volatilizing ethylacetate, i.e., the time from starting feeding 47 kgs of the emulsion into the double pipe 10 until finishing feeding the slurry into the container 20 was about 31 min. The slurry after the second de-solvent process had a weight about 41 kgs, ethylacetate in a remained amount of 1.3% by weight and a solid content of 32% by weight. The slurry had a temperature not higher than 40° C.

[Third Process]: Next, 41 kgs of the emulsion were fed at a feeding speed (A) of 90 kgs/hr into the double pipe 10 when the inner pipe 12 (3) have an inner wall surface temperature of 60° C. and an inner pressure of 50 mmHg (6.7 kPa). The emulsion was heated while the temperature of a liquid film flow of the emulsion was maintained at a glass transition temperature of the parent particle or less through the wall surface of the pipe to volatilize ethylacetate. The inner pipe 12 (3) has a heat-transfer area (S) of 0.18 m², a length of 2 m, a heat-transfer surface diameter 28.4 mm and a circumferential length (L) of the heat-transfer surface of 89.2 mm. The time for volatilizing ethylacetate, i.e., the time from starting feeding 41 kgs of the emulsion into the double pipe 10 until finishing feeding the slurry into the container 20 was about 27 min. The slurry after the third de-solvent process had a weight about 39 kgs, ethylacetate in a remained amount of 0.5% by weight and a solid content of 34% by weight. The slurry had a temperature not higher than 40° C.

[Fourth Process]: Next, 39 kgs of the emulsion were fed at a feeding speed (A) of 90 kgs/hr into the double pipe 10 when the inner pipe 12 (4) have an inner wall surface temperature of 60° C. and an inner pressure of 50 mmHg (6.7 kPa). The emulsion was heated while the temperature of a liquid film flow of the emulsion was maintained at a glass transition temperature of the parent particle or less through the wall surface of the pipe to volatilize ethylacetate. The inner pipe 12 (4) has a heat-transfer area (S) of 0.18 m², a length of 2 m, a heat-transfer surface diameter 28.4 mm and a circumferential length (L) of the heat-transfer surface of 89.2 mm. The time for volatilizing ethylacetate, i.e., the time from starting feeding 39 kgs of the emulsion into the double pipe 10 until finishing feeding the slurry into the container 20 was about 26 min. The slurry after the fourth de-solvent process had a weight about 37 kgs, ethylacetate in a remained amount of 0.2% by weight and a solid content of 36% by weight. The slurry had a temperature not higher than 40° C.

[Fifth Process]: Next, 37 kgs of the emulsion were fed at a feeding speed (A) of 90 kgs/hr into the double pipe 10 when the inner pipe 12 (5) have an inner wall surface temperature of 60° C. and an inner pressure of 50 mmHg (6.7 kPa). The emulsion was heated while the temperature of a liquid film flow of the emulsion was maintained at a glass transition temperature of the parent particle or less through the wall surface of the pipe to volatilize ethylacetate. The inner pipe 12 (5) has a heat-transfer area (S) of 0.18 m², a length of 2 m, a heat-transfer surface diameter 28.4 mm and a circumferential length (L) of the heat-transfer surface of 89.2 mm. The time for volatilizing ethylacetate, i.e., the time from starting feeding 37 kgs of the emulsion into the double pipe 10 until finishing feeding the slurry into the container 20 was about 25 min. The slurry after the fourth de-solvent process had a weight about 36 kgs, ethylacetate in a remained amount of 0.1% by weight and a solid content of 37% by weight. The slurry had a temperature not higher than 40° C. The concentration ratio of the solid content in the slurry before an organic solvent was volatilized to that thereof after the organic solvent was volatilized was 1.68.

Next, the slurry fed into the container 20 was placed in a tank having a jacket and capacity of 40 L. After the slurry was aged at a jacket temperature of 45° C., the slurry was filtered, washed, dried and classified with a wind force to prepare spherical parent particles.

Next, 100 parts of the parent toner particles and 0.25 parts of charge controlling agent BONTRON E-84 from Orient Chemical Industries, Ltd. were mixed by a Q-type mixer from Mitsui Mining Co., Ltd., wherein a peripheral speed of a turbine blade thereof was 50 m/sec. This mixing operation included 5 cycles of 2 min mixing (total 10 min) and 1 min pausing. Next, 0.5 parts of hydrophobic silica H2000 from Clariant (Japan) K.K. were mixed therein at a peripheral speed of 15 m/sec, which included 5 cycles of 30 sec mixing and 1 min pausing, to prepare a toner.

The de-solvent conditions of the organic solvent in the emulsion (second liquid), the time taken for volatilizing, the content of ethylacetate in the emulsion, the solid content in the emulsion [the slurry content (a) before volatilization], the slurry temperature after volatilization, the remaining ethylacetate amount in the slurry, the slurry content (b) after volatilization, a concentration ratio [(b)/(a)] of the slurry content (b) to the slurry content (a), and a sear due to liquid out in Example 1 are shown in Tables 1-1 and 1-2.

### Example 2

The procedure for preparation of the toner in Example 1 was repeated except for changing the amounts of the aqueous medium 1 and the toner constituents dispersion 1.

### (Preparation of Second Liquid)

27 kgs of the toner constituents liquid 1 were mixed with 33 kgs of the aqueous medium 1 to be reacted with each other while stirred for 30 min to prepare 60 kgs of an emulsion 2. The emulsion (second liquid) has a viscosity of 650 mPa·sec when measured by Brookfield viscometer at 60 rpm and a temperature of 25° C. The emulsion included ethylacetate in an amount of 22% by weight and a solid content (a slurry solid content before an organic solvent is volatilized) in an amount of 25% by weight.

### (Volatilization of Organic Solvent)

An organic solvent in the emulsion (second liquid) was volatilized using the double pipe 10 in FIG. 1 in the following five processes under respective conditions.

[First Process]: 60 kgs of the emulsion were fed at a feeding speed (A) of 120 kgs/hr into the double pipe 10 when the inner pipe 12(1) have an inner wall surface temperature of 60° C. and an inner pressure of 75 mmHg (10 kPa). The emulsion was heated while the temperature of a liquid film flow of the emulsion was maintained at a glass transition temperature of the parent particle or less through the wall surface of the pipe to volatilize ethylacetate. The inner pipe 12 (1) has a heat-transfer area (S) of 0.18 m², a length of 2 m, a heat-transfer surface diameter 28.4 mm and a circumferential length (L) of the heat-transfer surface of 89.2 mm. The time for volatilizing ethylacetate, i.e., the time from starting feeding 60 kgs of the emulsion into the double pipe 10 until finishing feeding the slurry into the container 20 was about 30 min. The slurry after the first de-solvent process had a weight about 44 kgs, ethylacetate in a remained amount of 10% by weight and a solid content of 34% by weight. The slurry had a temperature not higher than 40° C.

[Second Process]: Next, 44 kgs of the emulsion were fed at a feeding speed (A) of 120 kgs/hr into the double pipe 10 when the inner pipe 12 (2) have an inner wall surface temperature of 65° C. and an inner pressure of 60 mmHg (8 kPa). The emulsion was heated while the temperature of a liquid film flow of the emulsion was maintained at a glass transition temperature of the parent particle or less through the wall surface of the pipe to volatilize ethylacetate. The inner pipe 12 (2) has a heat-transfer area (S) of 0.18 m², a length of 2 m, a heat-transfer surface diameter 28.4 mm and a circumferential length (L) of the heat-transfer surface of 89.2 mm. The time for volatilizing ethylacetate, i.e., the time from starting feeding 44 kgs of the emulsion into the double pipe 10 until finishing feeding the slurry into the container 20 was about 22 min. The slurry after the second de-solvent process had a weight about 40 kgs, ethylacetate in a remained amount of 2.5% by weight and a solid content of 38% by weight. The slurry had a temperature not higher than 40° C.

[Third Process]: Next, 41 kgs of the emulsion were fed at a feeding speed (A) of 90 kgs/hr into the double pipe 10 when the inner pipe 12 (3) have an inner wall surface temperature of 65° C. and an inner pressure of 50 mmHg (6.7 kPa). The emulsion was heated while the temperature of a liquid film flow of the emulsion was maintained at a glass transition temperature of the parent particle or less through the wall surface of the pipe to volatilize ethylacetate. The inner pipe 12 (3) has a heat-transfer area (S) of 0.18 m², a length of 2 m, a heat-transfer surface diameter 28.4 mm and a circumferential length (L) of the heat-transfer surface of 89.2 mm. The time for volatilizing ethylacetate, i.e., the time from starting feeding 41 kgs of the emulsion into the double pipe 10 until finishing feeding the slurry into the container 20 was about 20 min. The slurry after the third de-solvent process had a weight about 38 kgs, ethylacetate in a remained amount of 1.0% by weight and a solid content of 40% by weight. The slurry had a temperature not higher than 40° C.

[Fourth Process]: Next, 38 kgs of the emulsion were fed at a feeding speed (A) of 90 kgs/hr into the double pipe 10 when the inner pipe 12 (4) have an inner wall surface temperature of 65° C. and an inner pressure of 50 mmHg (6.7 kPa). The emulsion was heated while the temperature of a liquid film flow of the emulsion was maintained at a glass transition temperature of the parent particle or less through the wall surface of the pipe to volatilize ethylacetate. The inner pipe 12 (4) has a heat-transfer area (S) of 0.18 m², a length of 2 m, a heat-transfer surface diameter 28.4 mm and a circumferential length (L) of the heat-transfer surface of 89.2 mm. The time for volatilizing ethylacetate, i.e., the time from starting feeding 38 kgs of the emulsion into the double pipe 10 until finishing feeding the slurry into the container 20 was about 19 min. The slurry after the fourth de-solvent process had a weight about 37 kgs, ethylacetate in a remained amount of 0.5% by weight and a solid content of 41% by weight. The slurry had a temperature not higher than 40° C.

[Fifth Process]: Next, 37 kgs of the emulsion were fed at a feeding speed (A) of 120 kgs/hr into the double pipe 10 when the inner pipe 12 (5) have an inner wall surface temperature of 65° C. and an inner pressure of 50 mmHg (6.7 kPa). The emulsion was heated while the temperature of a liquid film flow of the emulsion was maintained at a glass transition temperature of the parent particle or less through the wall surface of the pipe to volatilize ethylacetate. The inner pipe 12 (5) has a heat-transfer area (S) of 0.18 m², a length of 2 m, a heat-transfer surface diameter 28.4 mm and a circumferential length (L) of the heat-transfer surface of 89.2 mm. The time for volatilizing ethylacetate, i.e., the time from starting feeding 37 kgs of the emulsion into the double pipe 10 until finishing feeding the slurry into the container 20 was about 18 min. The slurry after the fourth de-solvent process had a weight about 36 kgs, ethylacetate in a remained amount of 0.2% by weight and a solid content of 42% by weight. The slurry had a temperature not higher than 40° C. The concentration ratio of the solid content in the slurry before an organic solvent was volatilized to that thereof after the organic solvent was volatilized was 1.68.

The de-solvent conditions of the organic solvent in the emulsion (second liquid), etc. in Example 2 are shown in Table 1.

### Comparative Example 1

The procedure for preparation of toner in the First Process in Example 1 was repeated except for changing the feeding speed (A) 90 kgs/hr to 30 kgs/hr and the length of the inner pipe 12 from 2 m to 4 m. Then, ethylacetate volatilization process took 120 min. The slurry after the first de-solvent process had a weight about 28 kgs, ethylacetate in a remained amount of 0.7% by weight and a solid content of 47% by weight. The inner wall surface of the inner pipe 12 had a sear. The slurry had a temperature not higher than 50° C. The concentration ratio of the solid content in the slurry before an organic solvent was volatilized to that thereof after the organic solvent was volatilized was 2.14. The de-solvent conditions of the organic solvent in the emulsion (second liquid), etc. in Comparative Example 1 are shown in Tables 1-1 and 1-2.

### Comparative Example 2

24 kgs of the toner constituents liquid 1 were mixed with 36 kgs of the aqueous medium 1 to be reacted with each other while stirred for 30 min to prepare 60 kgs of an emulsion 3. The emulsion (second liquid) has a viscosity of 600 mPa·sec when measured by Brookfield viscometer at 60 rpm and a temperature of 25° C. The emulsion included ethylacetate in an amount of 19% by weight and a solid content (a slurry solid content before an organic solvent is volatilized) in an amount of 23% by weight.

The procedure for preparation of toner in the First Process in Comparative Example 1 was repeated except for using the emulsion 3. Then, ethylacetate volatilization process took 120 min. The slurry after the first de-solvent process had a weight about 28 kgs, ethylacetate in a remained amount of 0.6% by weight and a solid content of 47% by weight. The inner wall surface of the inner pipe 12 had a sear. The concentration ratio of the solid content in the slurry before an organic solvent was volatilized to that thereof after the organic solvent was volatilized was 2.14. The de-solvent conditions of the organic solvent in the emulsion (second liquid), etc. in Comparative Example 2 are shown in Tables 1-1 and 1-2.

TABLE 1-1

| | | | | | | | SCE [a] |
|---|---|---|---|---|---|---|---|
| | VE | | | | | CEE | (*) |
| | [mPa · | IPHTA | IPL | IPD | FS | [% by | [% by |
| | sec] | [m²] | [m] | [mm] | [kgs/hr] | weight] | weight] |
| Example 1 | 500 | 0.18 | 2 | 28.4 | 90 | 20 | 22 |
| Example 2 | 650 | 0.18 | 2 | 28.4 | 120 | 22 | 25 |
| Compara- | 500 | 0.18 | 4 | 28.4 | 30 | 20 | 22 |
| tive | | | | | | | |
| Example 1 | | | | | | | |
| Compara- | 600 | 0.18 | 4 | 28.4 | 30 | 19 | 23 |
| tive | | | | | | | |
| Example 2 | | | | | | | |

VE: Viscosity of Emulsion
IPHTA: Inner Pipe Heat-Transfer Area
IPL: Inner Pipe Length
FS: Feeding Speed
CEE: Content of Ethylacetate in Emulsion
SCE: Solid Content in Emulsion
(*): Slurry Content before volatilization

TABLE 1-2

| | | Vacuum | | | AERSAV | SCSAV [b] | | |
|---|---|---|---|---|---|---|---|---|
| | D-S | [mmHg] | TVE | STAV | [% by | [% by | | |
| | [PRCS] | (kPa) | [min] | [° C.] | weight] | weight] | [b]/[a] | SDLO |
| Example 1 | First | 75 (10) | 40 | 40 or less | 6.3 | 28 | 1.27 | None |
| | Second | 60 (8) | 31 | 40 or less | 1.3 | 32 | 1.45 | None |
| | Third | 50 (6.7) | 27 | 40 or less | 0.5 | 34 | 1.54 | None |
| | Fourth | 50 (6.7) | 26 | 40 or less | 0.2 | 36 | 1.63 | None |
| | Fifth | 50 (6.7) | 25 | 40 or less | 0.1 | 37 | 1.68 | None |
| Example 2 | First | 75 (10) | 30 | 40 or less | 10 | 34 | 1.36 | None |
| | Second | 60 (8) | 22 | 40 or less | 2.5 | 38 | 1.52 | None |
| | Third | 50 (6.7) | 20 | 40 or less | 1.0 | 40 | 1.6 | None |
| | Fourth | 50 (6.7) | 19 | 40 or less | 0.5 | 41 | 1.64 | None |
| | Fifth | 50 (6.7) | 18 | 40 or less | 0.2 | 42 | 1.68 | None |
| Comparative | First | 75 (10) | 120 | 50 or less | 0.7 | 47 | 2.14 | Yes |
| Example 1 | | | | | | | | |
| Comparative | First | 75 (10) | 120 | 50 or less | 0.6 | 47 | 2.04 | Yes |
| Example 2 | | | | | | | | |

D-S: De-solvent
PRCS: Process
TVE: Time for Volatilizing Ethylacetate
STAV: Slurry Temperature After Volatilization
AERSAV: Amount of Ethylacetate Remaining in Slurry After Volatilization
SCSAV: Solid Content in Slurry After Volatilization
SDLO: Sear Due to Liquid out

The parent particles and toners prepared in Examples 1 and 2 and Comparative Examples 1 and 2 were evaluated by the following methods.

Their glass transition point, volume-average particle diameter (Dv), ratio (Dv/Dn) of the volume-average particle diameter (Dv) to the number-average particle diameter (Dn), content of parent particles having a particle diameter not greater than 2 μm, an average circularity of parent particles, and shape factors SF-1 and SF-2 of thereof are shown in Table 2.

The evaluation results of their image density, image granularity, sharpness, background fouling, toner scattering, cleanability, charge stability, fixability (fixable minimum temperature and fixable maximum temperature), and heat resistant storage stability are shown in Table 3.

Methods of measuring the number-average molecular weight and weight-average molecular weight, the volume-average particle diameter of the modified layered inorganic mineral and the content of particles having a diameter not less than 1 μm in a masterbatch, the acid value, and the amount of ethylacetate remaining in slurry are described below as well.

### <Number-Average Molecular Weight and Weight-Average Molecular Weight>

The number-average molecular weight and weight-average molecular weight were measured by GPC (gel permeation chromatography) as follows. A column is stabilized in a heat chamber having a temperature of 40° C.; THF is put into the column at a speed of 1 ml/min as a solvent; 50 to 200 μl of a THF liquid-solution of a resin, having a sample concentration of from 0.05 to 0.6% by weight, is put into the column; and a molecular weight distribution of the sample is determined by using a calibration curve which is previously prepared using several polystyrene standard samples having a single distribution peak, and which shows the relationship between a count number and the molecular weight. As the standard polystyrene samples for making the calibration curve, for example, the samples having a molecular weight of 6×10², 2.1×10³, 4×10³, 1.75×10⁴, 5.1×10⁴, 1.1×10⁵, 3.9×10⁵, 8.6×10⁵, 2×10⁶ and 48×10⁶ from Pressure Chemical Co. or Tosoh Corporation are used. It is preferable to use at least 10 standard polystyrene samples. In addition, an RI (refraction index) detector is used as the detector.

<Volume-Average Particle Diameter of Modified Layered Inorganic Mineral in Masterbatch and Content Thereof Having a Particle Diameter not Less than 1 μM Therein>

A masterbatch and a resin were placed in ethylacetate including a dispersant Disperbyk-167 (BYK-Chemie GmbH) in an amount of 5% by weight so that a weight ratio of a modified layered inorganic mineral to the resin in the masterbacth is 0.1, and stirred for 12 hrs to prepare a sample. The masterbatch and the resin were controlled to be 5% by weight in total in the sample.

The particle diameter of the sample was measured by a laser Doppler Particle diameter distribution measurer nanotrac UPA-150EX from NIKKISO CO., LTD.

The measurement conditions are as follows:

distribution indication: volume;

channels: 52;

time: 15 sec

particle refraction index: 1.54

temperature: 25° C.;

particle form: nonspherical

viscosity (CP): 0.441

solvent refraction index: 1.37

solvent: ethylacetate

The sample was diluted with ethylacetate by a dropper or an injector, etc. so as to be from 1 to 100 while seeing sample loading.

### <Acid Value>

The acid value was measured according to the method described in JIS K0070-1992. Specifically, 0.5 g of a sample (resin) (0.3 g if soluble with ethylacetate) were placed in 120 ml of toluene and stirred for about 10 hrs at room temperature (23° C.) to be dissolved therein to prepare a solution. When not dissolved, dioxane or tetrahydrofuran, etc. was used. 30 ml of ethanol were further included in the solution. The acid value is specifically decided by the following procedure.

Measurer: potentiometric automatic titrator DL-53 Titrator from Metier-Toledo Limited

Electrode: DG113-SC from Metier-Toledo Limited

Analysis software: LabX Light Version 1.00.000

Temperature: 23° C.

The measurement conditions are as follows:

Stir
Speed [%]25
Time [s]15

EQP titration
Titrant/Sensot
   Titrant CH30Na
   Concentration [mol/L]0.1
   Sensor DG115
   Unit of measurement mV

Predispensing to volume

| | |
|---|---|
| Volume [ml] | 1.0 |
| Wait time [s] | 0 |

Titrant addition Dynamic

| | |
|---|---|
| dE(set) [mV] | 8.0 |
| dV(min) [mL] | 0.03 |
| dV(max) [mL] | 0.5 |

Measure mode Equilibrium controlled

| | |
|---|---|
| dE [mV] | 0.5 |
| dt [s] | 1.0 |
| t(min) [s] | 2.0 |
| t(max) [s] | 20.0 |

Recognition

| | |
|---|---|
| Threshold | 100.0 |
| Steepest jump only | No |
| Range | No |
| Tendency | None |

Termination

| | |
|---|---|
| at maximum volume [mL] | 10.0 |
| at potential | No |
| at slope | No |
| after number EQPs | Yes |
| n = 1 | |
| comb. Termination conditions | No |

Evaluation

| | |
|---|---|
| Procedure | Standard |
| Potential 1 | No |
| Potential 2 | No |
| Step for reevaluation | No |

### <Amount of Ethylacetate Remaining in Slurry>

4 g of toluene were measured in a measuring flask and diluted with DMF to prepare 500 ml of a reference solution. Next, 1.5 g of the slurry were diluted with DMF to prepare 50 ml of a solution. 10 ml of the reference solution was placed with a hole pipette in the solution, and which was stirred with a stirrer for 4 min at 400 rpm to prepare a slurry-diluted liquid. Further, the slurry-diluted liquid was set in an auto sampler of gas chromatograph GC-2010 from Shimadzu Corp. to measure. After the measurement, from a ratio between toluene in the reference solution and ethylacetate, an amount thereof remaining in the slurry was determined by a reference method. 2.0 μl of the slurry-diluted liquid was set therein. The measurement conditions are as follows.

### Sample Vaporizing Chamber

Injection mode: Split

Vaporizing chamber temperature: 180° C.

Carrier gas: He

Pressure: 40.2 kPa

Total flow: 56.0 ml/min

Column flow: 1.04 ml/min

Linear flow: 20.0 cm/sec

Purge flow: 3.0 ml/min

Split ratio: 50.0

### Column

Name: ZB-50

Thickness of liquid phase: 0.25 μm

Length: 30.0 m

Inner diameter: 0.32 mm ID

Column maximum temperature: 340° C.

### Column Oven

Column temperature: 60° C.

Temperature program: 60° C. hold 6 min-heating speed 60° C./min-230° C. hold 5 min

### Detector

Detector temperature: 250° C.

Makeup gas: N₂/Air

Makeup flow: 30.0 ml/min

N₂ flow: 47.0 ml/min

Air flow: 400 ml/min

### <Glass Transition Point>

The glass transition temperature was measured by Rigaku THERMOFLEX TG8110 from RIGAKU Corp. at a programming rate of 10° C./min. Specifically, at first, about 10 mg of a sample in an aluminum container was loaded on a holder unit, which was set in an electric oven. After the sample was heated in the oven at from a room temperature to 150° C. and a programming speed of 10° C./min, the sample was left for 10 min at 150° C. After the samples was cooled to have a room temperature and left for 10 min, the sample was heated again in a nitrogen environment to have a temperature of 150° C. at a programming speed of 10° C./min and DSC measurement of the sample was performed. Tg was determined from a contact point between a tangent of a heat absorption curve close to Tg and base line using TG-DSC system an analyzer in TG-DSC system TAS-100 from RIGAKU Corp.

### <Number-Average Particle Diameter (Dn) and Volume-Average Particle Diameter (Dv)>

the number-average particle diameter and the volume-average particle diameter were measured by a Coulter counter TA-II from Beckman Coulter, Inc. as follows:

0.1 to 5 ml of a surfactant (alkylbenzene sulfonate salt) Neogen SC-A from Dai-ichi Kogyo Seiyaku Co., Ltd. was included as a dispersant in 100 to 150 ml of the electrolyte ISOTON R-II from Coulter Scientific Japan, Ltd.;

2 to 20 mg of a sample were included in the electrolyte and dispersed by an ultrasonic disperser for about 1 to 3 min to prepare a sample dispersion liquid; and

a volume and a number of the toner particles for each of the following channels are measured by the above-mentioned measurer using an aperture of 100 μm to determine a weight distribution and a number distribution:

2.00 to 2.52 μm; 2.52 to 3.17 μm; 3.17 to 4.00 μm; 4.00 to 5.04 μm; 5.04 to 6.35 μm; 6.35 to 8.00 μm; 8.00 to 10.08 μm; 10.08 to 12.70 μm; 12.70 to 16.00 μm; 16.00 to 20.20 μm; 20.20 to 25.40 μm; 25.40 to 32.00 μm; and 32.00 to 40.30 μm.

In the present invention, an Interface producing a number distribution and a volume distribution from Nikkaki Bios Co., Ltd. and a personal computer PC9801 from NEC Corp. are connected with the Coulter Multisizer II to measure the average particle diameter and particle diameter distribution.

<Average-Circularity and Content of Particles Having a Diameter not Greater than 2 μM>

The average circularity and the content of particles having a diameter not greater than 2 μm were measured by FPIA-2100 from SYSMEX CORPORATION and an analysis software FPIA-2100 Data Processing Program for FPIA version 00-10 was used. Specifically, 0.1 to 0.5 g of a sample and 0.5 ml of a surfactant (alkylbenzenesulfonate Neogen SC-A from Dai-ichi Kogyo Seiyaku Co., Ltd.) having a concentration of 10% by weight were mixed with a micro spatel in a glass beaker having a capacity of 100 ml, and 80 ml of ion-exchange water was added to the mixture. The mixture was dispersed by an ultrasonic disperser from HONDA ELECTRONICS CO., LTD. for 3 min. The average circularity and the content of particles having a diameter not greater than 2 μm were measured until the dispersion had a concentration of from 5,000 to 15,000 pieces/μl.

### <SF-1 and SF-2>

SF-1 and SF-2 (shape factors) were determined by randomly photographing 300 particles of a sample with an FE-SEM (S-4200) from Hitachi, Ltd. and analyzing the photographed image with an image analyzer Luzex AP from NIRECO Corp through an interface.

### <Image Density> [ID]

After 150,000 images of an image chart having an image area of 50% were produced in a monochrome mode by a digital full-color copier imagio Color 2800 from Ricoh Company, Ltd., a solid image was produced on a Ricoh 6000 paper from Ricoh Company, Ltd., and the image density was measured by X-Rite from X-Rite, Inc.

Very good: 1.8 to less than 2.2

Good: 1.4 to less than 1.8

Poor: 1.2 to less than 1.4

Very poor: less than 1.2

### <Image Granularity and Sharpness> [IGS]

Mono-color images were produced by a digital full-color copier imagio Color 2800 from Ricoh Company, Ltd., and visually observed to evaluate the image granularity and sharpness.

Very good: as good as an offset printing

Good: slightly worse than offset printing

Poor: considerably worse than offset printing

Very poor: as poor as conventional electrophotographic image

### <Background Fouling> [BF]

After 30,000 images of an image chart having an image area of 50% were produced in a monochrome mode by a digital full-color copier imagio Color 2800 from Ricoh Company, Ltd., while a blank image was developed, imagio Color 2800 was turned off to transfer the developer on the photoreceptor after developed onto an adhesive tape. A difference of image density between the adhesive tape and a brand-new adhesive tape was measured by 938 spectrodensitometer from X-Rite, Inc. The evaluation results were classified to 4 grades (Very good; Good; Poor; Very poor).

### <Toner Scattering> [TS]

After 50,000 images of an image chart having an image area of 50% were produced in a monochrome mode by a digital full-color copier imagio Color 2800 from Ricoh Company, Ltd., the inner toner contamination was evaluated.

Good: No problem

Poor: practically no problem

Very poor: noticeably contaminated

### <Cleanability> [CLN]

A residual toner on a photoreceptor after cleaned was transferred with a Scotch Tape from Sumitomo 3M Ltd. onto a white paper at the beginning, after 1,000 and after 100,000 images were produced. Density of the white paper was measured by Macbeth reflection densitometer RD514. When a density difference between the white paper the residual toner was transferred to and a blank white paper was not greater than 0.01, the cleanability was determined as good. When greater than 0.01, the cleanability was determined as poor.

### <Charge Stability> [CS]

In an environment of high temperature 40° C. and high humidity 90% Rh or low temperature 10° C. and low humidity 15% Rh, while 100,000 images of an image chart having an image area of 7% were produced in a monochrome mode by a digital full-color copier imagio Color 2800 from Ricoh Company, Ltd., the developer was partially sampled per 1,000 images and a charge quantity of the toner was measured by blow-off method.

Good: variation of charge quantity was less than 5 μC/g

Poor: not less than 5 5 μC/g and less than 10 μC/g

Very poor: Not less than 10 μC/g

The charge quantity of the toner was measured by TB-200 from Toshiba Chemical Corp. after 10 g of the toner and 100 g of ferrite carrier were placed in a stainless pot until its capacity is filled by 30% and stirred for 10 min at 100 rpm.

### <Fixable Minimum Temperature> [MiT]

A copier MF2200 using a TEFLON roller (a registered trademark) as a fixing roller from Ricoh Company, Ltd., the fixer in which was modified was used to produce images on receiving papers TYPE 6200 from Ricoh Company, Ltd. The fixable minimum temperature was determined under image forming conditions of a paper feeding linear speed of 120 to 150 mm/sec, a surface pressure of 1.2 Kgf/cm² and a nip width of 3 mm.

Excellent: less than 140° C.

Very good: not less than 140° C. and less than 150° C.

Good: not less than 150° C. and less than 160° C.

Poor: not less than 160° C. and less than 170° C.

Very poor: not less than 170° C.

### <Fixable Maximum Temperature> [MaT]

A copier MF2200 using a TEFLON roller (a registered trademark) as a fixing roller from Ricoh Company, Ltd., the fixer in which was modified was used to produce images on receiving papers TYPE 6200 from Ricoh Company, Ltd. The fixable maximum temperature was determined under image forming conditions of a paper feeding linear speed of 50 mm/sec, a surface pressure of 2.0 Kgf/cm² and a nip width of 4.5 mm.

Excellent: not less than 200° C.

Very good: not less than 190° C. and less than 200° C.

Good: not less than 180° C. and less than 190° C.

Poor: not less than 170° C. and less than 180° C.

Very poor: less than 170° C.

### <Heat Resistant Storage Stability> [HRSS]

After the toner was stored at 50° C. for 8 hrs, the toner was sieved with a 42 mesh sieve for 2 min to measure a residual ratio thereof on the mesh.

Very good: less than 10%

Good: not less than 10% less than 20%

Poor: not less than 20% less than 30%

Very poor: not less than 30%

TABLE 2

| | Particle Diameter · Shape Property | | | | | | |
|---|---|---|---|---|---|---|---|
| | | | 2 μm or | | | | |
| | Dv | | less [% by | Circu- | | | Tg |
| | [μm] | Dv/Dn | Number] | larity | SF-1 | SF-2 | [° C.] |
| Example 1 | 5.4 | 1.13 | 3.5 | 0.96 | 130 | 131 | 54.5 |
| Example 2 | 5.2 | 1.12 | 3.1 | 0.95 | 137 | 135 | 54.2 |
| Comparative | 6.7 | 1.21 | 5.2 | 0.94 | 148 | 138 | 54.1 |
| Example 1 | | | | | | | |
| Comparative | 6.4 | 1.19 | 4.2 | 0.95 | 136 | 135 | 55.3 |
| Example 2 | | | | | | | |

TABLE 3

| | | | | | | CS | | Fix | | |
|---|---|---|---|---|---|---|---|---|---|---|
| | ID | IGS | BF | TS | CLN | HH | LL | MiT | MaT | HRSS |
| Example 1 | Very | Good | Good | Good | Good | Good | Good | Exl | Exl | Good |
| | good | | | | | | | | | |
| Example 2 | Very | Good | Good | Good | Good | Good | Good | Exl | Exl | Good |
| | good | | | | | | | | | |
| Comparative | Good | Poor | Very | Poor | Good | Good | Good | Good | Good | Good |
| Example 1 | | | poor | | | | | | | |
| Comparative | Good | Poor | Very | Poor | Good | Poor | Poor | Very | Exl | Good |
| Example 2 | | | poor | | | | | poor | | |

Fix: fixability
HH: high temperature high humidity
LL: low temperature low humidity
Exl: excellent

Table 3 shows either of the toners in Examples 1 and 2, having a parent particle, prepared by a method comprising:

dissolving or dispersing toner constituents comprising at least one of a binder resin and a binder resin precursor, a colorant and a release agent in an organic solvent to prepare a first liquid;

emulsifying or dispersing the first liquid in an aqueous medium to prepare a second liquid having a viscosity of from 50 to 800 mPa·sec when measured by Brookfield viscometer at 60 rpm and a temperature of 25° C.; and

flowing the second liquid almost vertically down along the wall surface of a pipe in which the air pressure is depressurized to have a pressure not greater than 70 kPa as a liquid film five times while keeping a temperature of the second liquid not higher than a glass transition temperature of the parent particle through the wall surface of the pipe to volatilize the organic solvent,

wherein a solid content (b) of a slurry after the organic solvent is volatilized is from 15 to 50%, and a ratio [(b)/(a)] of the solid content (b) to a solid content (a) of a slurry before the organic solvent is volatilized is from 1.05 to 2.00, has good evaluation results.

To the contrary, in Comparative Example 1, the inner wall surface of the inner pipe had a sear in the process of volatilizing an organic solvent, and the resultant toner produced images having poor image granularity and sharpness, background fouling. Further, the toner scattered and did not have sufficient fixability.

Further, in Comparative Example 2, the inner wall surface of the inner pipe had a sear in the process of volatilizing an organic solvent as well, and the resultant toner produced images having poor image granularity and sharpness, background fouling. Further, the toner scattered and did not have sufficient fixability.

Namely, the method of preparing the toner having a parent particle of the present invention can efficiently prepare a toner having good reproducibility of a microscopic dot and cleanability.

This application claims priority and contains subject matter related to Japanese Patent Application No. 2009-181236, filed on Aug. 4, 2009, the entire contents of which are hereby incorporated by reference.

Having now fully described the invention, it will be apparent to one of ordinary skill in the art that many changes and modifications can be made thereto without departing from the spirit and scope of the invention as set forth therein.

1. A method of preparing toner having a parent particle, comprising:
dissolving or dispersing toner constituents comprising at least one of a binder resin and a binder resin precursor, a colorant and a release agent in an organic solvent to prepare a first liquid;
emulsifying or dispersing the first liquid in an aqueous medium to prepare a second liquid having a viscosity of from 50 to 800 mPa·sec when measured by Brookfield viscometer at 60 rpm and a temperature of 25° C.; and
in at least two stages pouring the second liquid almost vertically downward along a wall surface of a pipe in which the air pressure is not greater than 70 kPa as a liquid film while keeping a temperature of the second liquid not higher than a glass transition temperature of the parent particle through the wall surface of the pipe to volatilize the organic solvent,
wherein a solid content (b) of a slurry after the organic solvent is volatilized is from 15 to 50%, and a ratio [(b)/(a)] of the solid content (b) to a solid content (a) of a slurry before the organic solvent is volatilized is from 1.05 to 2.00.

2. The method of claim 1, wherein the binder resin precursor is a compound having an active hydrogen group and a polymer having a functional group reactable with the active hydrogen group.

3. The method of claim 2, wherein the compound having an active hydrogen group and the polymer having a functional group reactable with the active hydrogen group are reacted with each other in preparing the second liquid.

4. The method of claim 2, wherein the polymer having a functional group reactable with an active hydrogen group is a polyester resin having an isocyanate group.

5. The method of claim 4, wherein the polyester resin having an isocyanate group has a weight-average molecular weight of from 3,000 to 20,000.

6. The method of claim 1, wherein the toner constituents further comprise a modified layered inorganic mineral in which a metallic cation is at least partially ion-exchanged with an organic cation.

7. The method of claim 6, wherein the modified layered inorganic mineral is employed as a complex formed of a mixture with the binder resin when the first liquid is prepared, and has a volume-average particle diameter of from 0.1 to 0.55 μm and includes particles having a diameter not less than 1 μm in an amount not greater than 15% by volume.

8. The method of claim 6, wherein the parent particle includes the modified layered inorganic mineral in an amount of from 0.1 to 5% by weight.

9. The method of claim 6, wherein the organic cation is a quaternary ammonium ion.

10. The method of claim 1, wherein the parent particle has a volume-average particle diameter of from 3 to 7 μm.

11. The method of claim 1, wherein the parent particle has a ratio of a volume-average particle diameter to a number-average particle diameter of from 1.0 to 1.2.

12. The method of claim 1, wherein the parent particle has an average circularity of from 0.94 to 0.99.

13. The method of claim 1, wherein the toner includes parent particles having a particle diameter not greater than 2 μm in an amount of 10% or less by number.

14. The method of claim 1, wherein the parent particle has a shape factor SF-1 of from 110 to 200, and a shape factor SF-2 of from 110 to 300.

15. The method of claim 1, wherein the binder resin comprises a polyester resin.

16. The method of claim 15, wherein the binder resin includes the polyester resin in an amount of from 50 to 100% by weight.

17. The method of claim 15, wherein the polyester resin includes tetrahydrofuran-soluble components having a weight-average molecular weight of from 1,000 to 30,000.

18. The method of claim 15, wherein the polyester resin has a glass transition temperature of from 35 to 65° C.

19. The method of claim 1, wherein the parent particle has a glass transition temperature of from 40 to 70° C.

20. A toner prepared by the method according to claim 1.
